(19) United States
(12) Patent Application Publication
(10) Pub. No.: US 2023/0090907 A1
(43) Pub. Date: Mar. 23, 2023

(54) PUCCH RESOURCE SELECTION OF SPS PUCCH COMPRISING HARQ AND CSI COLLISION WITH DL SYMBOLS

(71) Applicant: QUALCOMM Incorporated, San Diego, CA (US)

(72) Inventors: Konstantinos DIMOU, New York, NY (US); Yan ZHOU, San Diego, CA (US); Tao LUO, San Diego, CA (US); Faris RASSAM, El Cajon, CA (US); Sanghoon KIM, San Jose, CA (US)

(21) Appl. No.: 17/948,005

(22) Filed: Sep. 19, 2022

Related U.S. Application Data
(60) Provisional application No. 63/246,616, filed on Sep. 21, 2021.

(51) Int. Cl. H04W 72/12; H04L 1/18; H04L 5/00

(52) U.S. Cl. CPC H04W 72/1257; H04L 1/1854; H04L 5/0057

(57) ABSTRACT

Aspects described herein relate to avoiding downlink symbol collisions. In an example, a UE may scheduling a HARQ message and a CSI message on a first slot for transmission on a PUCCH to a network entity based on a SPS configuration, wherein the first slot is configured in a first slot format; determining whether the first slot format of the slot changes to a second slot format prior to transmission of the HARQ message and the CSI message on the PUCCH; forgoing transmission of the CSI message based on the determination that the first slot format of the first slot changes to the second slot format; and rescheduling the HARQ message on a second slot for transmission on the PUCCH to the network entity based on the determination that the first slot format of the slot changes to the second slot format.

### CROSS-REFERENCE TO RELATED APPLICATION(S)

The present application claims benefit of U.S. Provisional Application No. 63/246,616 entitled “PUCCH RESOURCE SELECTION OF SPS PUCCH COMPRISING HARQ AND CSI COLLISION WITH DL SYMBOLS” filed Sep. 21, 2021, which is assigned to the assignee hereof and hereby expressly incorporated by reference herein.

### BACKGROUND

### Technical Field

Aspects of the present disclosure relate generally to wireless communication systems, and more particularly, to apparatuses and methods of physical uplink control channel (PUCCH) resource selection to avoid hybrid automatic repeat request (HARQ) message and a channel status information (CSI) message collision in a downlink symbol.

### Introduction

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as NR) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

For example, for various communications technology such as, but not limited to NR, full duplex communication with respect to integrated access and backhaul (IAB) implementations may increase transmission speed and flexibility but also transmission complexity. Thus, improvements in wireless communication operations may be desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, the disclosure provides a method of wireless communication for a user equipment (UE). The method may include scheduling a hybrid automatic repeat request (HARQ) message and a channel state information (CSI) message in a first slot for transmission on a physical uplink control channel (PUCCH) to a network entity based on a semi-persistent scheduling (SPS) configuration, wherein the first slot is configured in a first slot format; determining whether the first slot format of the slot changes to a second slot format prior to transmission of the HARQ message and the CSI message on the PUCCH in the first slot; forgoing transmission of the CSI message based on the determination that the first slot format of the first slot changes to the second slot format; and rescheduling the HARQ message on a second slot for transmission on the PUCCH to the network entity based on the determination that the first slot format of the slot changes to the second slot format, wherein the second slot is configured in the second slot format.

In a further example, an apparatus for wireless communication is provided that includes a transceiver, a memory configured to store instructions, and one or more processors communicatively coupled with the transceiver and the memory. The one or more processors are configured to execute the instructions to schedule a HARQ message and a CSI message in a first slot for transmission on a PUCCH to a network entity based on a SPS configuration, wherein the first slot is configured in a first slot format; determine whether the first slot format of the slot changes to a second slot format prior to transmission of the HARQ message and the CSI message on the PUCCH in the first slot; forgo transmission of the CSI message based on the determination that the first slot format of the first slot changes to the second slot format; and rescheduling the HARQ message on a second slot for transmission on the PUCCH to the network entity based on the determination that the first slot format of the slot changes to the second slot format, wherein the second slot is configured in the second slot format.

In another aspect, an apparatus for wireless communication is provided that includes means for scheduling a HARQ message and a CSI message in a first slot for transmission on a PUCCH to a network entity based on a SPS configuration, wherein the first slot is configured in a first slot format; means for determining whether the first slot format of the slot changes to a second slot format prior to transmission of the HARQ message and the CSI message on the PUCCH in the first slot; means for forgoing transmission of the CSI message based on the determination that the first slot format of the first slot changes to the second slot format; and means for rescheduling the HARQ message on a second slot for transmission on the PUCCH to the network entity based on the determination that the first slot format of the slot changes to the second slot format, wherein the second slot is configured in the second slot format.

In yet another aspect, a non-transitory computer-readable medium is provided including code executable by one or more processors to schedule a HARQ message and a CSI message in a first slot for transmission on a PUCCH to a network entity based on a SPS configuration, wherein the first slot is configured in a first slot format; determine whether the first slot format of the slot changes to a second slot format prior to transmission of the HARQ message and the CSI message on the PUCCH in the first slot; forgo transmission of the CSI message based on the determination that the first slot format of the first slot changes to the second slot format; and reschedule the HARQ message on a second slot for transmission on the PUCCH to the network entity based on the determination that the first slot format of the slot changes to the second slot format, wherein the second slot is configured in the second slot format.

In another aspect, the disclosure provides a method of wireless communication for a UE. The method may include scheduling a HARQ message and a CSI message on a first slot for transmission on a PUCCH to a network entity based on a SPS configuration, wherein the first slot is configured in a first slot format; determining whether the first slot format of the slot changes to a second slot format prior to transmission of the HARQ message and the CSI message on the PUCCH; determining availability of one or more PUCCH resources corresponding to the second slot format based on the determination that the first slot format of the slot changes to the second slot format; and rescheduling the HARQ message and the CSI message on a second slot for transmission on the PUCCH to the network entity based on the determination of the availability of the one or more PUCCH resources, wherein the second slot is configured in the second slot format.

In a further example, an apparatus for wireless communication is provided that includes a transceiver, a memory configured to store instructions, and one or more processors communicatively coupled with the transceiver and the memory. The one or more processors are configured to execute the instructions to schedule a HARQ message and a CSI message on a first slot for transmission on a PUCCH to a network entity based on a SPS configuration, wherein the first slot is configured in a first slot format; determine whether the first slot format of the slot changes to a second slot format prior to transmission of the HARQ message and the CSI message on the PUCCH; determine availability of one or more PUCCH resources corresponding to the second slot format based on the determination that the first slot format of the slot changes to the second slot format; and reschedule the HARQ message and the CSI message on a second slot for transmission on the PUCCH to the network entity based on the determination of the availability of the one or more PUCCH resources, wherein the second slot is configured in the second slot format.

In another aspect, an apparatus for wireless communication is provided that includes means for scheduling a HARQ message and a CSI message on a first slot for transmission on a PUCCH to a network entity based on a SPS configuration, wherein the first slot is configured in a first slot format; means for determining whether the first slot format of the slot changes to a second slot format prior to transmission of the HARQ message and the CSI message on the PUCCH; means for determining availability of one or more PUCCH resources corresponding to the second slot format based on the determination that the first slot format of the slot changes to the second slot format; and means for rescheduling the HARQ message and the CSI message on a second slot for transmission on the PUCCH to the network entity based on the determination of the availability of the one or more PUCCH resources, wherein the second slot is configured in the second slot format.

In yet another aspect, a non-transitory computer-readable medium is provided including code executable by one or more processors to schedule a HARQ message and a CSI message on a first slot for transmission on a PUCCH to a network entity based on a SPS configuration, wherein the first slot is configured in a first slot format; determine whether the first slot format of the slot changes to a second slot format prior to transmission of the HARQ message and the CSI message on the PUCCH; determine availability of one or more PUCCH resources corresponding to the second slot format based on the determination that the first slot format of the slot changes to the second slot format; and reschedule the HARQ message and the CSI message on a second slot for transmission on the PUCCH to the network entity based on the determination of the availability of the one or more PUCCH resources, wherein the second slot is configured in the second slot format.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2A is a diagram illustrating an example of a first 5G NR frame, in accordance with various aspects of the present disclosure;

FIG. 2B is a diagram illustrating an example of DL channels within a 5G NR subframe, in accordance with various aspects of the present disclosure;

FIG. 2C is a diagram illustrating an example of a second 5G NR frame, in accordance with various aspects of the present disclosure;

FIG. 2D is a diagram illustrating an example of UL channels within a 5G NR subframe, in accordance with various aspects of the present disclosure, in accordance with various aspects of the present disclosure;

FIG. 3 illustrates example aspects of a sidelink slot structure, in accordance with various aspects of the present disclosure;

FIG. 4 is a block diagram illustrating an example of a MIMO communication system including a base station and a user equipment (UE), in accordance with various aspects of the present disclosure;

FIG. 5 is an example diagram illustrating a semi-persistent scheduling (SPS) hybrid automatic repeat request (HARQ) collision with downlink symbols during wireless communications between a network entity and a UE, in accordance with various aspects of the present disclosure;

FIG. 6 is an example diagram illustrating a SPS HARQ and channel status information (CSI) collision with downlink symbols during wireless communications between a network entity and a UE, in accordance with various aspects of the present disclosure;

FIG. 7 is an example diagram illustrating a HARQ deferral during wireless communications between a network entity and a UE, in accordance with various aspects of the present disclosure;

FIG. 8 is another example diagram illustrating a HARQ and CSI collision with downlink symbols during wireless communications between a network entity and a UE, in accordance with various aspects of the present disclosure;

FIG. 9 is an example diagram illustrating a HARQ deferral during wireless communications between a network entity and a UE, in accordance with various aspects of the present disclosure;

FIG. 10 is a flow chart illustrating an example of a method for wireless communications at a UE in accordance with various aspects of the present disclosure;

FIG. 11 is a flow chart illustrating another example of a method for wireless communications at a UE in accordance with various aspects of the present disclosure;

FIG. 12 is a block diagram illustrating an example of a network entity (also referred to as a base station), in accordance with various aspects of the present disclosure; and

FIG. 13 is a block diagram illustrating an example of a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to physical uplink control channel (PUCCH) resource selection to avoid hybrid automatic repeat request (HARQ) message and a channel status information (CSI) message collision in a downlink symbol. A user equipment (UE) in communication with another device (e.g., a base station) may experience a slot format change during semi-persistent scheduling (SPS) configuration communications. As a result of this slot format change, one or more HARQ messages and CSI message may experience collision if scheduled in a downlink symbol of a new slot with a different slot format.

Hence, the present disclosure provides for rescheduling of at least one of a HARQ message and a CSI message based on a slot format change during an SPS configuration of PUCCH. As such, the present implementations provide for scheduling a HARQ message and a CSI message in a first slot for transmission on a PUCCH to a network entity based on a SPS configuration, wherein the first slot is configured in a first slot format; determining whether the first slot format of the slot changes to a second slot format prior to transmission of the HARQ message and the CSI message on the PUCCH in the first slot; forgoing transmission of the CSI message based on the determination that the first slot format of the first slot changes to the second slot format; and rescheduling the HARQ message on a second slot for transmission on the PUCCH to the network entity based on the determination that the first slot format of the slot changes to the second slot format, wherein the second slot is configured in the second slot format.

In another aspect, the present implementations provide a method of wireless communication for a UE. The method may include scheduling a HARQ message and a CSI message on a first slot for transmission on a PUCCH to a network entity based on a SPS configuration, wherein the first slot is configured in a first slot format; determining whether the first slot format of the slot changes to a second slot format prior to transmission of the HARQ message and the CSI message on the PUCCH; determining availability of one or more PUCCH resources corresponding to the second slot format based on the determination that the first slot format of the slot changes to the second slot format; and rescheduling the HARQ message and the CSI message on a second slot for transmission on the PUCCH to the network entity based on the determination of the availability of the one or more PUCCH resources, wherein the second slot is configured in the second slot format.

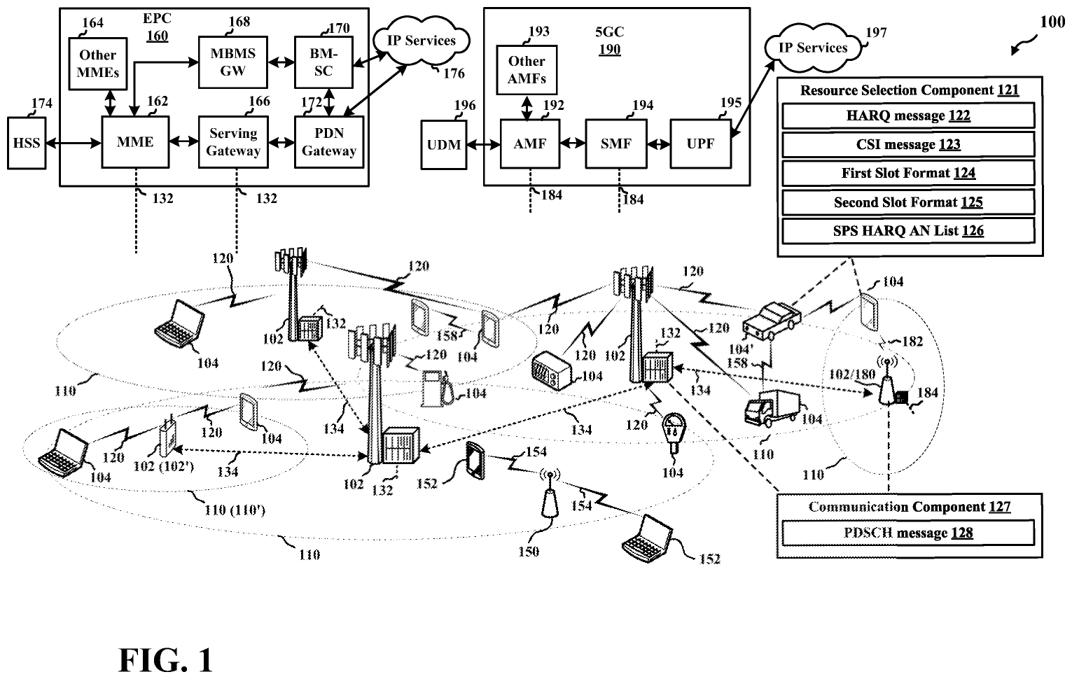

The described features will be presented in more detail below with reference to FIGS. 1-13.

As used in this application, the terms “component,” “module,” “system” and the like are intended to include a computer-related entity, such as but not limited to hardware, software, a combination of hardware and software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Techniques described herein may be used for various wireless communication systems such as CDMA, TDMA, FDMA, OFDMA, SC-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) NR networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102, which may also be referred to as a network entity, may include macro cells (high power cellular base station) and/or small cells (low power cellular base station). The macro cells can include base stations. The small cells can include femtocells, picocells, and microcells. In an example, the base stations 102 may also include gNBs 180, as described further herein.

In one example, some nodes such as base station 102/gNB 180, may have a communication component 127 that is configured to communicate with one or more UEs 104/104′, as described herein. For example, base station 102/gNB 180 and communication component 127 may transmit a PDSCH message 128 during SPS configuration. Though a base station 102/gNB 180 is shown as having the communication component 127, this is one illustrative example, and substantially any node or type of node may include a communication component 127 for providing corresponding functionalities described herein.

In some examples, the UE 104 may have resource selection component 121 that reschedules at least one of HARQ message 122 and CSI message 123 during SPS configuration of the PUCCH. The resource selection component 121 may be configured to schedule a HARQ message 122 and a CSI message 123 on a first slot for transmission on a PUCCH to a network entity 102/180 based on a SPS configuration, wherein the first slot is configured in a first slot format. The resource selection component 121 may determine whether the first slot format 124 of the slot changes to a second slot format 125 prior to transmission of the HARQ message 122 and the CSI message 123 on the PUCCH. The resource selection component 121 may forgo transmission of the CSI message 123 based on the determination that the first slot format 124 of the first slot changes to the second slot format 125. The resource selection component 121 may reschedule the HARQ message 122 on a second slot for transmission on the PUCCH to the network entity 102/180 based on the determination that the first slot format 124 of the slot changes to the second slot format 125, wherein the second slot is configured in the second slot format 125.

In some examples, the resource selection component 121 scheduling a HARQ message 122 and a CSI message 123 on a first slot for transmission on a PUCCH to a network entity 102/180 based on a SPS configuration, wherein the first slot is configured in a first slot format 124. The resource selection component 121 may determine whether the first slot format 124 of the slot changes to a second slot format 125 prior to transmission of the HARQ message 122 and the CSI message 123 on the PUCCH. The resource selection component 121 may determine availability of one or more PUCCH resources corresponding to the second slot format 125 based on the determination that the first slot format 124 of the slot changes to the second slot format 125. The resource selection component 121 may reschedule the HARQ message 122 and the CSI message 123 on a second slot for transmission on the PUCCH to the network entity 102/180 based on the determination of the availability of the one or more PUCCH resources, wherein the second slot is configured in the second slot format 125.

In some examples, the resource selection component 121 may schedule a HARQ message 122 and a CSI message 123 on a first slot for transmission on a PUCCH to a network entity 102/180 based on a SPS configuration, wherein the first slot is configured in a first slot format 124. The resource selection component 121 may determine whether the first slot format 124 of the slot changes to a second slot format 125 prior to transmission of the HARQ message 122 and the CSI message 123 on the PUCCH. The resource selection component 121 may forgo transmission of the CSI message 123 based on the determination that the first slot format 124 of the first slot changes to the second slot format 125. The resource selection component 121 may select a first available PUCCH resource of one or more PUCCH resources from a SPS PUCCH AN list 126 that configures the one or more PUCCH resources per a HARQ ACK codebook for scheduling transmission of a SPS HARQ message 122. In one example, such a list can be received as a part of an RRC configuration, for example, in a parameter or information element such as SPS-PUCCH-AN-List that indicates a list of PUCCH resources for SPS HARQ ACK. The resource selection component 121 may reschedule the HARQ message 122 as the SPS HARQ message on the first available PUCCH resource of a second slot for transmission on the PUCCH to the network entity 102/180 based on the determination that the first slot format 124 of the slot changes to the second slot format 125, wherein the second slot is configured in the second slot format 125.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 132, 134 and/or 184 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a AMF 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a positioning system (e.g., satellite, terrestrial), a multimedia device, a video device, a digital audio player (e.g., MP3 player), a camera, a game console, a tablet, a smart device, robots, drones, an industrial/manufacturing device, a wearable device (e.g., a smart watch, smart clothing, smart glasses, virtual reality goggles, a smart wristband, smart jewelry (e.g., a smart ring, a smart bracelet)), a vehicle/a vehicular device, a meter (e.g., parking meter, electric meter, gas meter, water meter, flow meter), a gas pump, a large or small kitchen appliance, a medical/healthcare device, an implant, a sensor/actuator, a display, or any other similar functioning device. Some of the UEs 104 may be referred to as IoT devices (e.g., meters, pumps, monitors, cameras, industrial/manufacturing devices, appliances, vehicles, robots, drones, etc.). IoT UEs may include MTC/enhanced MTC (eMTC, also referred to as CAT-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

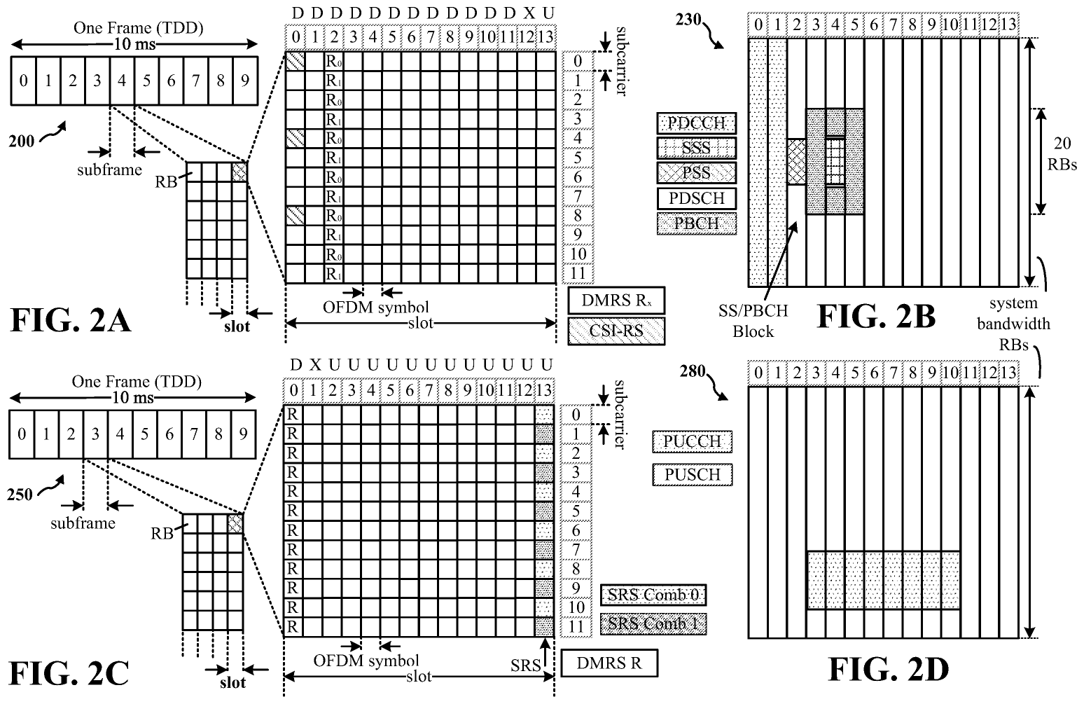

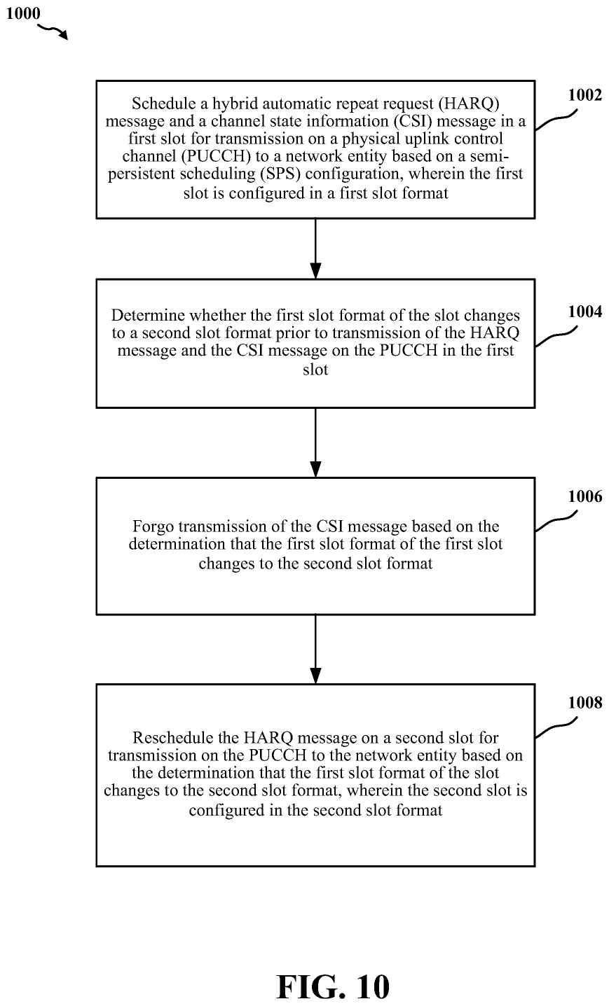

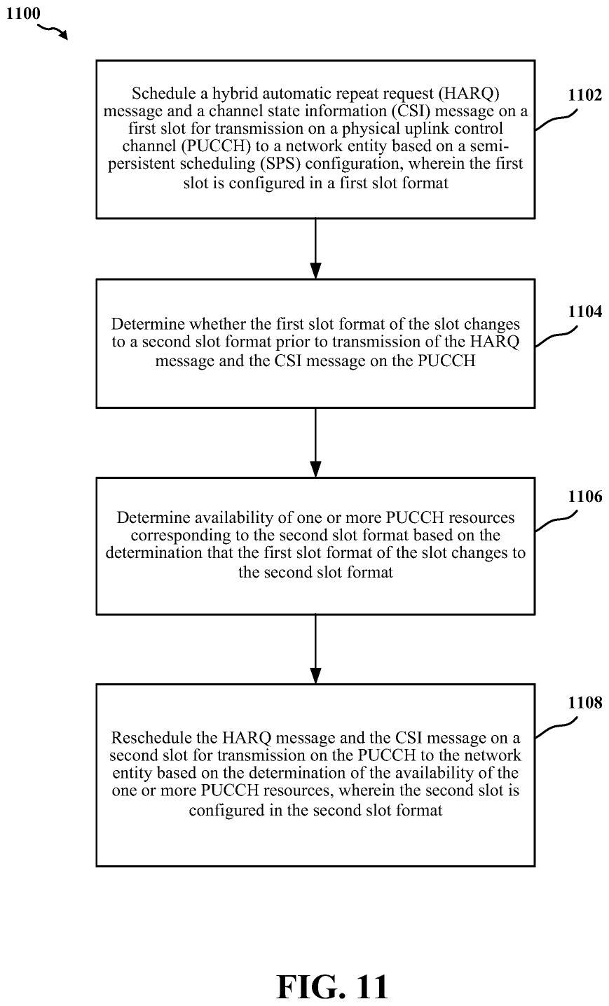

Turning now to FIGS. 2-13, aspects are depicted with reference to one or more components and one or more methods that may perform the actions or operations described herein, where aspects in dashed line may be optional. Although the operations described below in FIGS. 10 and 11 are presented in a particular order and/or as being performed by an example component, it should be understood that the ordering of the actions and the components performing the actions may be varied, depending on the implementation. Moreover, it should be understood that the following actions, functions, and/or described components may be performed by a specially-programmed processor, a processor executing specially-programmed software or computer-readable media, or by any other combination of a hardware component and/or a software component capable of performing the described actions or functions.

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2\hat{ }μ*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

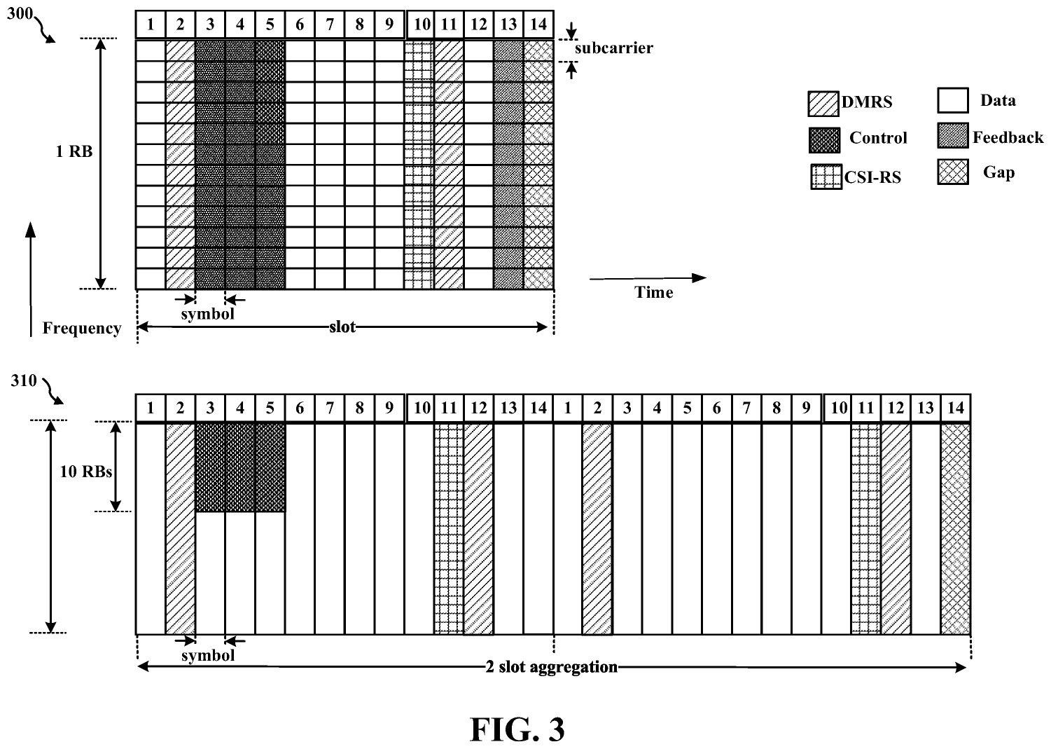

FIG. 3 illustrates example diagrams 300 and 310 illustrating examples slot structures that may be used for wireless communication between UE 104 and UE 104′, e.g., for sidelink communication. The slot structure may be within a 5G/NR frame structure. Although the following description may be focused on 5G NR, the concepts described herein may be applicable to other similar areas, such as LTE, LTE-A, CDMA, GSM, and other wireless technologies. This is merely one example, and other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 3 symbols. Each slot may include 7 or 14 symbols, depending on the slot configuration. For slot configuration 0, each slot may include 14 symbols, and for slot configuration 1, each slot may include 7 symbols. Diagram 300 illustrates a single slot transmission, e.g., which may correspond to a 0.5 ms transmission time interval (TTI). Diagram 310 illustrates an example two-slot aggregation, e.g., an aggregation of two 0.5 ms TTIs. Diagram 300 illustrates a single RB, whereas diagram 310 illustrates N RBs. In diagram 310, 10 RBs being used for control is merely one example. The number of RBs may differ.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 3, some of the REs may comprise control information, e.g., along with demodulation RS (DMRS). FIG. 3 also illustrates that symbol(s) may comprise CSI-RS. The symbols in FIG. 3 that are indicated for DMRS or CSI-RS indicate that the symbol comprises DMRS or CSI-RS REs. Such symbols may also comprise REs that include data. For example, if a number of ports for DMRS or CSI-RS is 1 and a comb-2 pattern is used for DMRS/CSI-RS, then half of the REs may comprise the RS and the other half of the REs may comprise data. A CSI-RS resource may start at any symbol of a slot, and may occupy 1, 3, or 4 symbols depending on a configured number of ports. CSI-RS can be periodic, semi-persistent, or aperiodic (e.g., based on DCI triggering). For time/frequency tracking, CSI-RS may be either periodic or aperiodic. CSI-RS may be transmitted in busts of two or four symbols that are spread across one or two slots. The control information may comprise Sidelink Control Information (SCI). At least one symbol may be used for feedback, as described herein. A symbol prior to and/or after the feedback may be used for turnaround between reception of data and transmission of the feedback. Although symbol 12 is illustrated for data, it may instead be a gap symbol to enable turnaround for feedback in symbol 13. Another symbol, e.g., at the end of the slot may be used as a gap. The gap enables a device to switch from operating as a transmitting device to prepare to operate as a receiving device, e.g., in the following slot. Data may be transmitted in the remaining REs, as illustrated. The data may comprise the data message described herein. The position of any of the SCI, feedback, and LBT symbols may be different than the example illustrated in FIG. 3. Multiple slots may be aggregated together. FIG. 3 also illustrates an example aggregation of two slot. The aggregated number of slots may also be larger than two. When slots are aggregated, the symbols used for feedback and/or a gap symbol may be different that for a single slot. While feedback is not illustrated for the aggregated example, symbol(s) in a multiple slot aggregation may also be allocated for feedback, as illustrated in the one slot example.

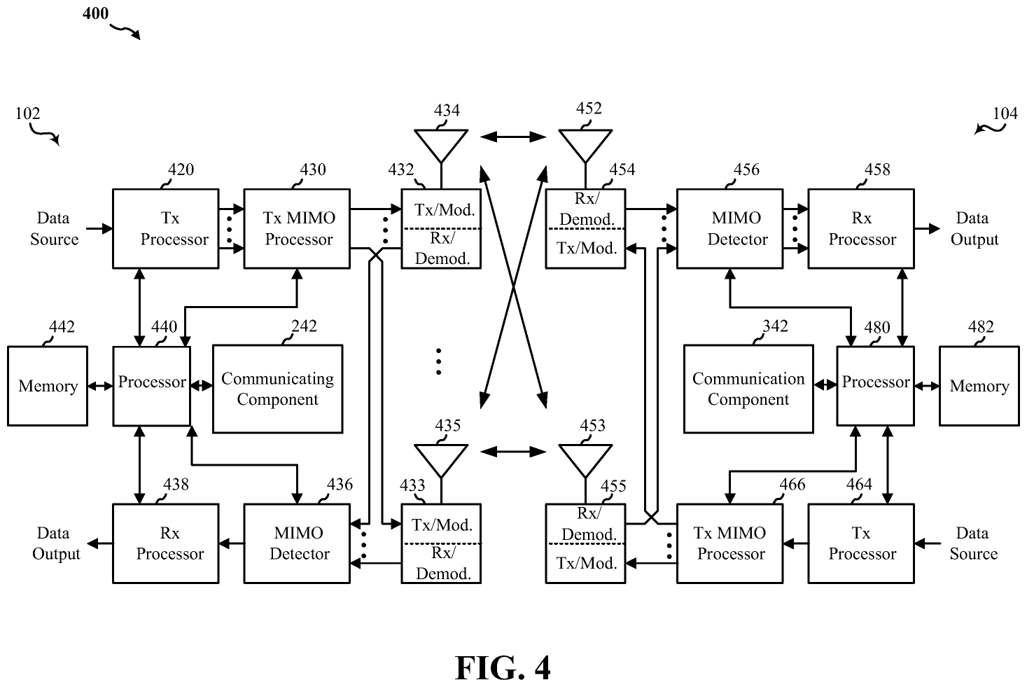

FIG. 4 is a block diagram of a MIMO communication system 400 including a base station 102, and a UE 104. The MIMO communication system 400 may illustrate aspects of the wireless communication access network 100 described with reference to FIG. 1. The base station 102 may be an example of aspects of the base station 102 described with reference to FIG. 1. The base station 102 may be equipped with antennas 434 and 435, and the UE 104 may be equipped with antennas 452 and 453. In the MIMO communication system 400, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 420 may receive data from a data source. The transmit processor 420 may process the data. The transmit processor 420 may also generate control symbols or reference symbols. A transmit MIMO processor 430 may perform spatial processing (e.g., precoding) on data symbols, control symbols, or reference symbols, if applicable, and may provide output symbol streams to the transmit modulator/demodulators 432 and 433. Each modulator/demodulator 432 through 433 may process a respective output symbol stream (e.g., for OFDM, etc.) to obtain an output sample stream. Each modulator/demodulator 432 through 433 may further process (e.g., convert to analog, amplify, filter, and upconvert) the output sample stream to obtain a DL signal. In one example, DL signals from modulator/demodulators 432 and 433 may be transmitted via the antennas 434 and 435, respectively.

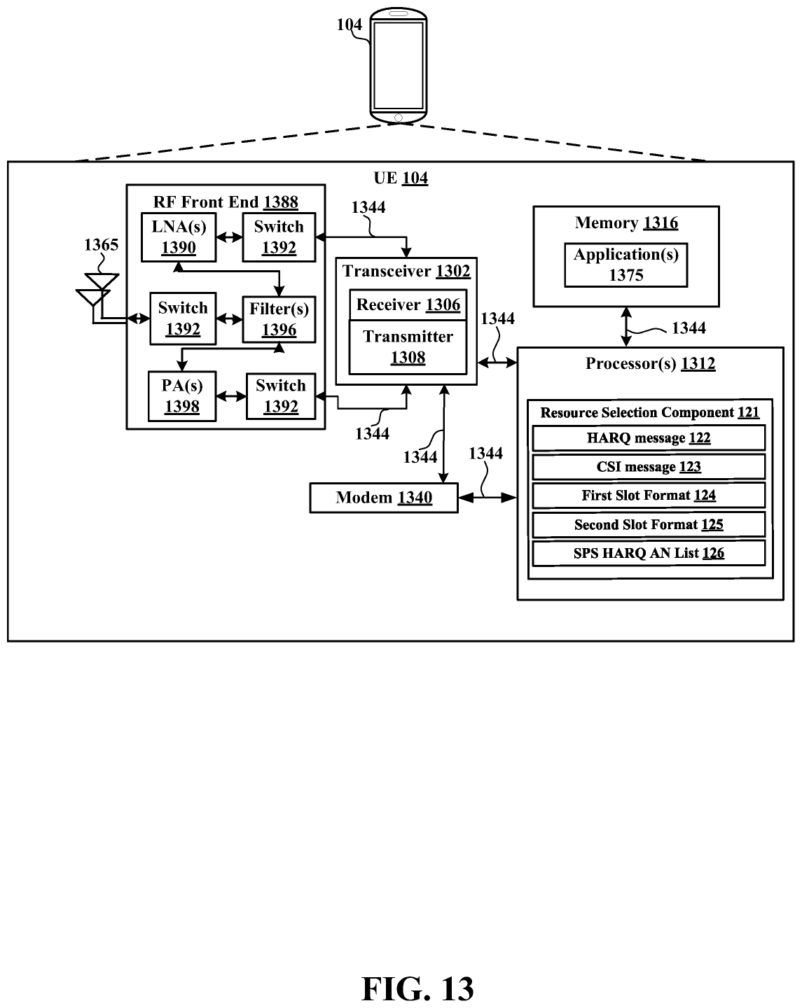

The UE 104 may be an example of aspects of the UEs 104 described with reference to FIGS. 1 and 13. At the UE 104, the UE antennas 452 and 453 may receive the DL signals from the base station 102 and may provide the received signals to the modulator/demodulators 454 and 455, respectively. Each modulator/demodulator 454 through 455 may condition (e.g., filter, amplify, downconvert, and digitize) a respective received signal to obtain input samples. Each modulator/demodulator 454 through 455 may further process the input samples (e.g., for OFDM, etc.) to obtain received symbols. A MIMO detector 456 may obtain received symbols from the modulator/demodulators 454 and 455, perform MIMO detection on the received symbols, if applicable, and provide detected symbols. A receive (Rx) processor 458 may process (e.g., demodulate, deinterleave, and decode) the detected symbols, providing decoded data for the UE 104 to a data output, and provide decoded control information to a processor 480, or memory 482.

The processor 480 may in some cases execute stored instructions to instantiate a resource selection component 121 (see e.g., FIGS. 1 and 13).

On the uplink (UL), at the UE 104, a transmit processor 464 may receive and process data from a data source. The transmit processor 464 may also generate reference symbols for a reference signal. The symbols from the transmit processor 464 may be precoded by a transmit MIMO processor 466 if applicable, further processed by the modulator/demodulators 454 and 455 (e.g., for SC-FDMA, etc.), and be transmitted to the base station 102 in accordance with the communication parameters received from the base station 102. At the base station 102, the UL signals from the UE 104 may be received by the antennas 434 and 435, processed by the modulator/demodulators 432 and 433, detected by a MIMO detector 436 if applicable, and further processed by a receive processor 438. The receive processor 438 may provide decoded data to a data output and to the processor 440 or memory 442. The processor 440 may in some cases execute stored instructions to instantiate a communication component 127 (see e.g., FIGS. 1 and 13).

The components of the UE 104 may, individually or collectively, be implemented with one or more ASICs adapted to perform some or all of the applicable functions in hardware. Each of the noted modules may be a means for performing one or more functions related to operation of the MIMO communication system 400. Similarly, the components of the base station 102 may, individually or collectively, be implemented with one or more ASICs adapted to perform some or all of the applicable functions in hardware. Each of the noted components may be a means for performing one or more functions related to operation of the MIMO communication system 400.

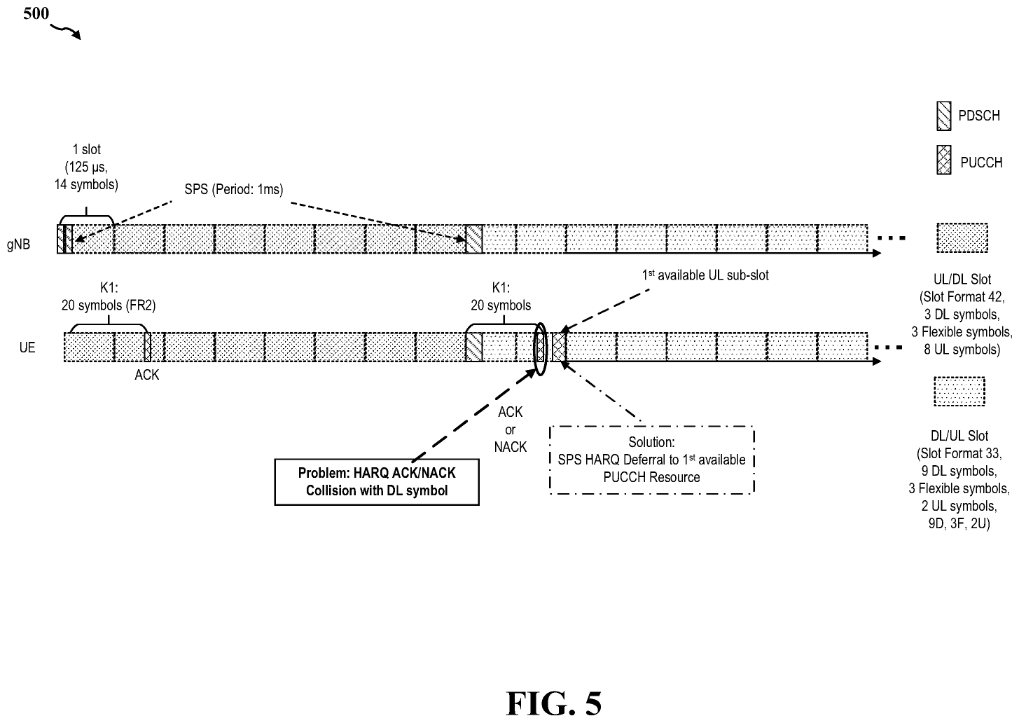

FIG. 5 illustrates an example 500 of wireless communication between devices based on an SPS configuration. Specifically, example 500 illustrates a SPS HARQ collision with downlink symbols during wireless communications between a gNB, e.g., base station 102/180 and a UE, such as UE 104. The communication may be based on a slot structure comprising aspects described in connection with FIG. 2. For example, the gNB and the UE may be configured to initially communicate using an SPS configuration with a first slot format. The first slot format may, for example, correspond to slot format 42 and include 3 downlink symbols, 3 flexible symbols, and 8 uplink symbols. The gNB may be configured to transmit a PDSCH message on the downlink symbol of a slot configured in the first slot format. Subsequently, the UE may receive the PDSCH message and schedule transmission of SPS HARQ ACK/NACK in a subsequent slot configured in the first slot format. The UE may, for example, utilize configuration information relating to an SPS-PUCCH-AN-List that provides a list of PUCCH resources for scheduling transmission of ACK/NACK, and based on the first slot format, determine an appropriate PUCCH resource or resources to transmit the SPS HARQ ACK/NACK and coordinate with the gNB to schedule the transmission.

In an aspect, due to a number of factors, including but not limited to, movement of the UE to a different physical location/cell, the first slot format may change to a second slot format. The second slot format may, for example, correspond to slot format 33 which includes 9 downlink symbols, 3 flexible symbols, and 2 uplink symbols. As a result of this slot format change, the already scheduled SPS HARQ message may now be scheduled in downlink symbols according to the second slot format. Hence, the UE may be configured to defer the transmission of the SPS HARQ message and reschedule the transmission of the SPS HARQ message to the first available PUCCH resource of a slot that is configured with the second slot format. In determining PUCCH resources for rescheduling the transmission of the SPS HARQ message, the UE may utilize configuration information relating to the SPS-PUCCH-AN-List, and based on the second slot format, determine an appropriate PUCCH resource or resources (e.g., first available PUCCH resource(s)) to transmit the SPS HARQ ACK/NACK and coordinate with the gNB to schedule the transmission.

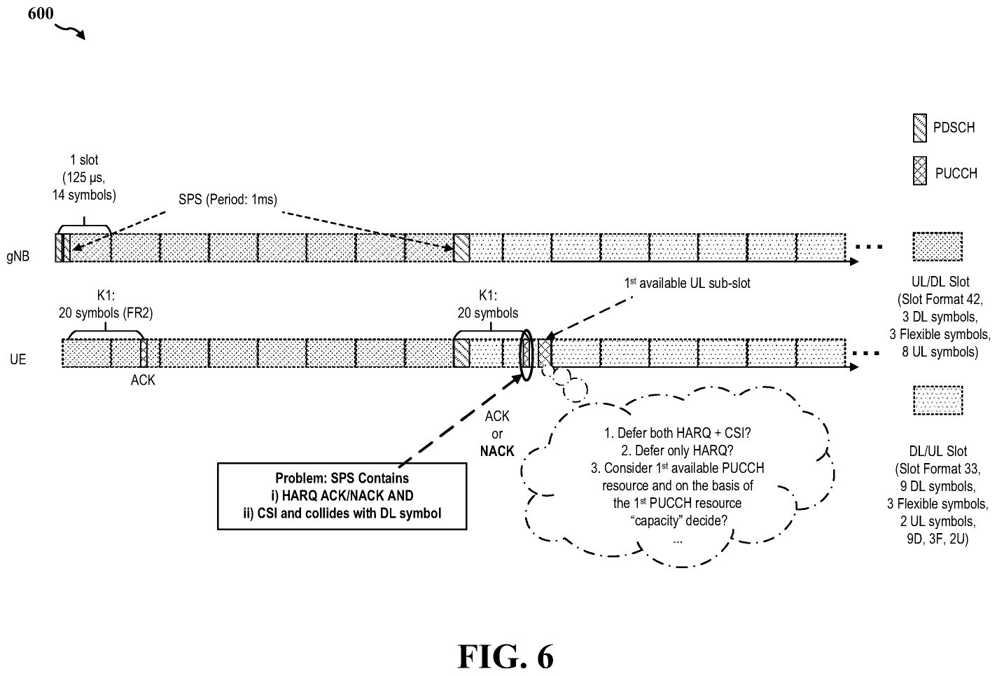

FIG. 6 illustrates an example 600 of a SPS HARQ and CSI collision during wireless communications. Specifically, example 600 illustrates a SPS HARQ and CSI collision with downlink symbols during wireless communications between a gNB, e.g., base station 102/180 and a UE, such as UE 104. The communication may be based on a slot structure comprising aspects described in connection with FIG. 2. For example, similar to FIG. 5, the gNB and the UE may be configured to initially communicate using an SPS configuration with a first slot format. In example 600, the UE may be configured to schedule both SPS HARQ ACK/NACK and a CSI message in response to receiving the PDSCH message. The UE may, for example, utilize configuration information relating to an SPS-PUCCH-AN-List that provides a list of PUCCH resources for scheduling transmission of ACK/NACK, and based on the first slot format, determine an appropriate PUCCH resource or resources to transmit the SPS HARQ ACK/NACK and coordinate with the gNB to schedule the transmission. The CSI message may correspond to a periodic CSI configured to be transmitted every Nth millisecond (e.g., every 8th millisecond) with the HARQ message in a PUCCH transmission. The UE may, for example, be configured for simultaneous HARQ-ACK-CSI transmissions. Without a slot format change, the PUCCH transmission for both the SPS HARQ message and the CSI message occurs in a resource from pucch-CSI-ResourceList, if a single CSI report transmission; if more than 1 CSI reports are transmitted, both SPS HARQ message and the CSI messages are transmitted in a resource from multi-CSI-PUCCH-ResourceList.

In an aspect, due to a slot format change from the first slot format to the second slot format, a scheduled transmission of the SPS HARQ ACK/NACK and CSI message may collide with a downlink symbol of a slot configured in the second slot format.

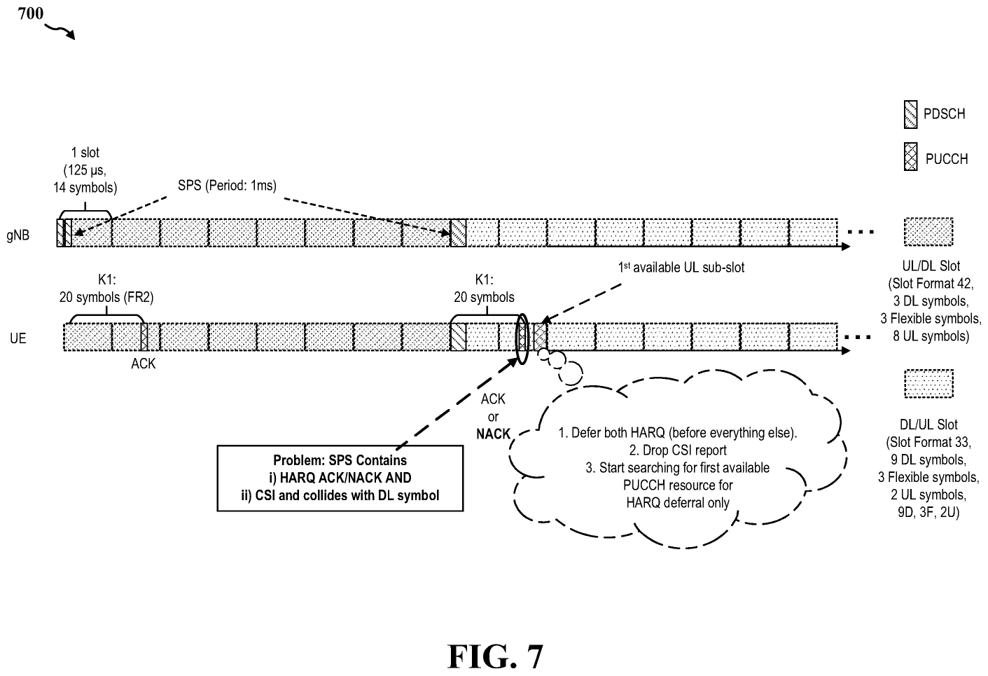

FIG. 7 is a diagram of an example 700 of HARQ deferral during SPS configured communications. Specifically, example 700 illustrates a SPS HARQ and CSI collision with downlink symbols during wireless communications between a gNB, e.g., base station 102/180 and a UE, such as UE 104. The communication may be based on a slot structure comprising aspects described in connection with FIG. 2. Following example 600, in example 700, when a slot format change occurs before a scheduled SPS HARQ message and CSI report has transmitted, the UE may forgo use of the pucch-CSI-ResourceList, i.e., forgo use of the resource from the pucch-CSI-ResourceList for the PUCCH transmission. Subsequently, the UE may begin searching for a first available PUCCH resource for transmitting the SPS HARQ ACK/NACK only. In an example, the SPS HARQ message may comprise a codebook of multiple bits, wherein the codebook corresponds to multiple carriers, carrier aggregation, and/or multiple SPS configurations. Similarly, the CSI message may correspond to multiple CSI reports corresponding to the codebook.

In an aspect, the UE may forgo transmission of the CSI message and defer only the SPS HARQ message based on the determination not to defer the CSI message (i.e., since the UE will not defer CSI, and since the SPS HARQ message and CSI message collide with a downlink symbol of a slot configured in the second slot format following a slot format change, the UE therefore will forgo transmission of the CSI message). The determination not to defer, i.e., the determination to forgo, the CSI message can be based on, for example, a maximum deferral time; for example, if the UE cannot find sufficient PUCCH resources to carry both the SPS HARQ message and the CSI message, in view of the available UL resources according to the second slot format, before the expiry of the maximum deferral time, the UE may determine not to defer, and thereby forgo, the CSI message.

In an aspect, the maximum deferral time may correspond to a parameter k1_def_max that is set to correspond to characteristics of the DL traffic. For example, the DL traffic may expire after a set period of time, e.g., 1 ms, and as such, k1_def_max is configured to include a maximum deferral time. If HARQ feedback for a given DL packet transmitted via SPS PDSCH, is transmitted after the maximum deferral time, i.e., due to the expiration of the DL traffic, the HARQ feedback for this specific DL packet becomes irrelevant.

In an aspect, the UE may be configured to reschedule transmission of the SPS HARQ ACK/NACK by searching for a first available PUCCH resource in one or more slots configured in the second slot format. For example, a subsequent slot following the initially scheduled slot for the SPS HARQ ACK/NACK transmission may be searched for available and/or unreserved PUCCH resources of an uplink symbol. If found, the UE may reschedule the SPS HARQ ACK/NACK transmission to the available PUCCH resource in the subsequent slot.

In an aspect, the UE may be enabled to defer both HARQ and CSI based on an availability of uplink resources. For example, the gNB may inform the UE via a downlink control information (DCI) and a SPS HARQ and CSI deferral field that the UE may defer both HARQ and CSI if potential collisions with downlink symbols are expected to occur. In another example, the gNB may broadcast the ability to defer both HARQ and CSI in the cell via system information (e.g., system information block (SIB), SIB X). In another example, the UE may trigger a request for HARQ and CSI deferral via a scheduling request (SR) message. In this example, the UE may trigger the request if the UE detects that the amount of uplink symbols in the current slot configuration exceeds a threshold indicating that the amount of symbols are large enough for transmission of both the HARQ and CSI.

In an aspect, for scenarios of high importance CSI reports (e.g., wideband CSI being used to detect beam blocking at FR 2), the gNB may configure the UE to defer both the HARQ and CSI report(s). In order to detect beam blocking on a specific beam (e.g., a beam with an identification (ID) number) the UE may measure across the entire bandwidth part (BWP) so that more than one beam is measured. Another type of CSI report used for detecting may include cell interference on specific resources. For example, the gNB may inform the UE via a DCI and a SPS HARQ and CSI deferral field to enable rescheduling of both the HARQ and CSI report(s).

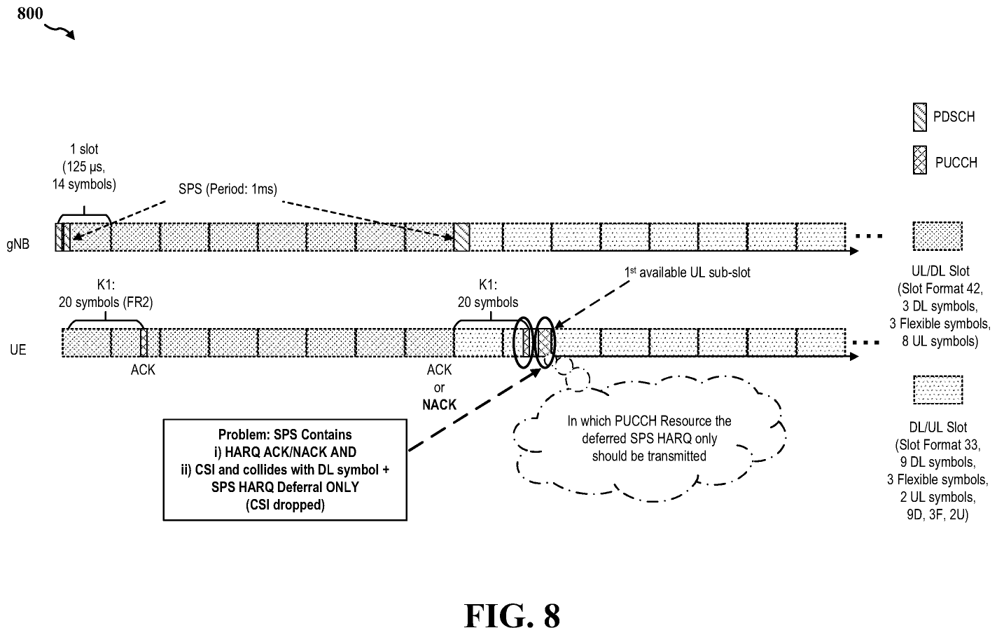

FIG. 8 is a diagram of an example 800 of a HARQ and CSI collision during wireless communications. Specifically, example 800 illustrates a SPS HARQ and CSI collision with downlink symbols during wireless communications between a gNB, e.g., base station 102/180 and a UE, such as UE 104. The communication may be based on a slot structure comprising aspects described in connection with FIG. 2. For example, similar to FIG. 5, the gNB and the UE may be configured to initially communicate using an SPS configuration with a first slot format. In example 800, the UE may be configured to schedule both a SPS HARQ ACK/NACK and a CSI message in response to receiving the PDSCH message. The UE may be configured with SPS-PUCCH-AN-List, pucch-CSI-ResourceList (i.e., single CSI report), and simultaneous HARQ-ACK-CSI.

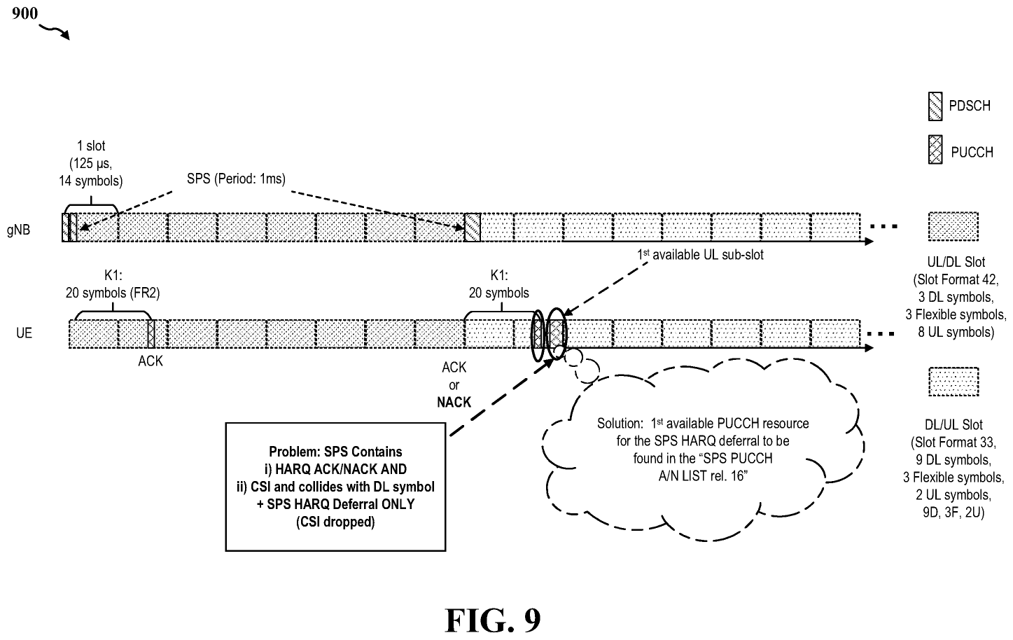

In an aspect, due to a slot format change from the first slot format to the second slot format, a scheduled transmission of the HARQ message and CSI message may now collide with a downlink symbol of a slot configured in the second slot format. If the UE determines to forgo the CSI message, and to defer the HARQ message only, then the UE still is to determine which PUCCH resource(s) to use for the deferred ACK/NACK. In one example, the UE can determine which PUCCH resource(s) to use as described below with reference to FIG. 9.

FIG. 9 is a diagram of another example 900 of an HARQ deferral during SPS configured communications. Specifically, example 900 illustrates a SPS HARQ and CSI collision with downlink symbols during wireless communications between a gNB, e.g., base station 102/180 and a UE, such as UE 104. The communication may be based on a slot structure comprising aspects described in connection with FIG. 2. For example, the UE may defer the SPS HARQ in one of the PUCCH resources of the SPS PUCCH AN List (e.g., as defined in a parameter or information element such as SPS-PUCCH-AN-List), for example, a first PUCCH resource or resources that is on the list and also is compatible with the second slot format. In particular, the UE may select the PUCCH resource mapped to the corresponding UCI content (i.e., deferred SPS HARQ bits). The deferred SPS HARQ bits may be multiplexed with new HARQ bits.

Turning now to FIGS. 10 and 11, aspects are depicted with reference to one or more components and one or more methods that may perform the actions or operations described herein, where aspects in dashed line may be optional. Although the operations described below in FIGS. 10 and 11 are presented in a particular order and/or as being performed by an example component, it should be understood that the ordering of the actions and the components performing the actions may be varied, depending on the implementation. Moreover, it should be understood that the following actions, functions, and/or described components may be performed by reference to one or more components of FIGS. 1, 2, 4, 12 and/or 13, as described herein, a specially-programmed processor, a processor executing specially-programmed software or computer-readable media, or by any other combination of a hardware component and/or a software component capable of performing the described actions or functions.

FIG. 10 illustrates a flow chart of an example of a method 1000 for wireless communication at a UE, such as the UE 104. In an example, a UE 104 can perform the functions described in method 1000 using one or more of the components described in FIGS. 1, 2, 4, and/or 13.

At block 1002, the method 1000 may schedule a HARQ message and a CSI message in a first slot for transmission on a PUCCH to a network entity based on a SPS configuration, wherein the first slot is configured in a first slot format. In an aspect, the resource selection component 121, e.g., in conjunction with processor(s) 1312, memory 1316, and/or transceiver 1302, may be configured to schedule a HARQ message 122 and a CSI message 123 in a first slot for transmission on a PUCCH to a network entity 102/180 based on a SPS configuration, wherein the first slot is configured in a first slot format 124. Thus, the UE 104, the processor(s) 1312, the resource selection component 121 or one of its subcomponents may define the means for scheduling a HARQ message and a CSI message in a first slot for transmission on a PUCCH to a network entity based on a SPS configuration, wherein the first slot is configured in a first slot format. For example, in an aspect, the UE 104 and/or the resource selection component 121 may process one or more instructions to place a HARQ message and a CSI message in a queue for transmission, and/or performs other signal processes such as described above with respect to FIG. 13.

At block 1004, the method 1000 may determine whether the first slot format of the slot changes to a second slot format prior to transmission of the HARQ message and the CSI message on the PUCCH in the first slot. In an aspect, the resource selection component 121, e.g., in conjunction with processor(s) 1312, memory 1316, and/or transceiver 1302, may be configured to determine whether the first slot format 124 of the slot changes to a second slot format 125 prior to transmission of the HARQ message 122 and the CSI message 123 on the PUCCH in the first slot. Thus, the UE 104, the processor(s) 1312, the resource selection component 121 or one of its subcomponents may define the means for determining whether the first slot format of the slot changes to a second slot format prior to transmission of the HARQ message and the CSI message on the PUCCH in the first slot. For example, in an aspect, the UE 104 and/or the resource selection component 121 may receive one or more signals that indicate a slot format change, and/or performs other signal processes such as described above with respect to FIG. 13.

At block 1006, the method 1000 may forgo transmission of the CSI message based on the determination that the first slot format of the first slot changes to the second slot format. In an aspect, the resource selection component 121, e.g., in conjunction with processor(s) 1312, memory 1316, and/or transceiver 1302, may be configured to forgo transmission of the CSI message 123 based on the determination that the first slot format 124 of the first slot changes to the second slot format 125. Thus, the UE 104, the processor(s) 1312, the resource selection component 121 or one of its subcomponents may define the means for forgoing transmission of the CSI message based on the determination that the first slot format of the first slot changes to the second slot format. For example, in an aspect, the UE 104 and/or the resource selection component 121 may process one or more instructions to not transmit a signal, and/or performs other signal processes such as described above with respect to FIG. 13.

At block 1008, the method 1000 may reschedule the HARQ message on a second slot for transmission on the PUCCH to the network entity based on the determination that the first slot format of the slot changes to the second slot format, wherein the second slot is configured in the second slot format. In an aspect, the resource selection component 121, e.g., in conjunction with processor(s) 1312, memory 1316, and/or transceiver 1302, may be configured to reschedule the HARQ message 122 on a second slot for transmission on the PUCCH to the network entity 102/180 based on the determination that the first slot format 124 of the slot changes to the second slot format 125, wherein the second slot is configured in the second slot format 125. Thus, the UE 104, the processor(s) 1312, the resource selection component 121 or one of its subcomponents may define the means for rescheduling the HARQ message on a second slot for transmission on the PUCCH to the network entity based on the determination that the first slot format of the slot changes to the second slot format, wherein the second slot is configured in the second slot format. For example, in an aspect, the UE 104 and/or the resource selection component 121 may process one or more instructions to place a HARQ message in a queue for transmission, and/or performs other signal processes such as described above with respect to FIG. 13.

In some aspects, the HARQ message 122 corresponds to a SPS HARQ ACK/NACK scheduled in response to an SPS PDSCH message based on the SPS configuration on the PUCCH.

In some aspects, the HARQ message 122 comprises a codebook of multiple bits.

In some aspects, the codebook corresponds to at least one of multiple carriers, carrier aggregation, and multiple SPS configurations.

In some aspects, the SPS configuration corresponds to a SPS PUCCH AN list 126 that configures one or more PUCCH resources per a HARQ ACK/NACK codebook for scheduling transmission of the HARQ message 122.

In some aspects, the CSI message 123 is configured for periodic transmission.

In some aspects, the resource selection component 121, e.g., in conjunction with processor(s) 1312, memory 1316, and/or transceiver 1302, may be configured to determine whether the second slot for transmission occurs within a maximum deferral time for transmission of rescheduled transmissions.

In some aspects, the resource selection component 121, e.g., in conjunction with processor(s) 1312, memory 1316, and/or transceiver 1302, configured to reschedule the HARQ message 122 on the second slot for transmission on the PUCCH to the network entity 102 further comprises rescheduling the HARQ message 122 on the second slot for transmission on the PUCCH to the network entity 102 based on the determination that the second slot for transmission occurs within the maximum deferral time for transmission of rescheduled transmissions.

In some aspects, the maximum deferral time for transmission of the rescheduled transmissions corresponds to a maximum number of slots after reception of a downlink message indicating expiration of a validity of the HARQ message 122 and the CSI message 123.

In some aspects, transmitting the HARQ message 122 and the CSI message 123 on the first slot on the PUCCH to the network entity 102/180 based on the determination that first slot format 124 of the slot does not change.

In some aspects, the resource selection component 121, e.g., in conjunction with processor(s) 1312, memory 1316, and/or transceiver 1302, configured to reschedule the HARQ message 122 on the second slot for transmission on the PUCCH to the network entity 102/180 further comprises forgoing transmission of the HARQ message 122 on the first slot; searching for a first available PUCCH resource in the second slot; and scheduling the HARQ message 122 on first available PUCCH resource of the second slot for transmission on the PUCCH to the network entity 102/180.

In some aspects, the resource selection component 121, e.g., in conjunction with processor(s) 1312, memory 1316, and/or transceiver 1302, configured to determine whether the first slot format 124 of the slot changes to the second slot format 125 prior to transmission of the HARQ message 122 and the CSI message 123 on the PUCCH further comprises identifying a symbol location within the first slot that is configured as an uplink symbol by the first slot format 124 for scheduled transmissions of the HARQ message 122 and the CSI message 123; and determining whether the symbol location within the first slot changes from the uplink symbol to a downlink symbol.

In some aspects, the resource selection component 121, e.g., in conjunction with processor(s) 1312, memory 1316, and/or transceiver 1302, configured to forgo transmission of the CSI message 123 based on the determination that the first slot format 124 of the first slot changes to the second slot format 124 further comprises forgoing transmission of the CSI message 123 in the symbol location within the first slot based on the determination that the symbol location within the first slot changes from the uplink symbol to the downlink symbol within the second slot.

In some aspects, the resource selection component 121, e.g., in conjunction with processor(s) 1312, memory 1316, and/or transceiver 1302, configured to reschedule the HARQ message 122 on the second slot for transmission on the PUCCH to the network entity 102/180 further comprises forgoing transmission of the HARQ message 122 in the symbol location within the first slot based on the determination that the symbol location within the first slot changes from the uplink symbol to the downlink symbol; searching for a first available PUCCH resource at a subsequent symbol location corresponding to an uplink symbol in the second slot; and scheduling the HARQ message 122 on first available PUCCH resource in the subsequent symbol location within the second slot for transmission on the PUCCH to the network entity 102/180.

In some aspects, the resource selection component 121, e.g., in conjunction with processor(s) 1312, memory 1316, and/or transceiver 1302, configured to search for the first available PUCCH resource at the subsequent symbol location further comprises searching for the first available PUCCH resource based on a payload size of the HARQ message 122.

In some aspects, the resource selection component 121, e.g., in conjunction with processor(s) 1312, memory 1316, and/or transceiver 1302, may be configured to select a first available PUCCH resource of one or more PUCCH resources from a SPS PUCCH AN list 126 that configures the one or more PUCCH resources per a HARQ ACK/NACK codebook for scheduling transmission of the HARQ message 122.

In some aspects, the resource selection component 121, e.g., in conjunction with processor(s) 1312, memory 1316, and/or transceiver 1302, configured to reschedule the HARQ message 122 on the second slot for transmission on the PUCCH to the network entity 102 further comprises rescheduling the HARQ message 122 on the selected first available PUCCH resource of a second slot for transmission on the PUCCH to the network entity 102 based on the determination that the first slot format 124 of the slot changes to the second slot format 125.

In some aspects, the resource selection component 121, e.g., in conjunction with processor(s) 1312, memory 1316, and/or transceiver 1302, configured to map the first available PUCCH resource to an uplink control information (UCI) content corresponding to one or more bits of the HARQ message 122.

In some aspects, the resource selection component 121, e.g., in conjunction with processor(s) 1312, memory 1316, and/or transceiver 1302, configured to reschedule the HARQ message 122 on the second slot for transmission on the PUCCH to the network entity 102 further comprises multiplexing one or more bits of HARQ message 122 with one or more bits of a new HARQ.

In some aspects, the resource selection component 121, e.g., in conjunction with processor(s) 1312, memory 1316, and/or transceiver 1302, configured to select the first available PUCCH resource of one or more PUCCH resources from the SPS PUCCH AN list 126 further comprises identifying from the one or more PUCCH resources that carriers a deferred payload of the HARQ message 122; determining whether a plurality of the one or more PUCCH resources are identified; and selecting from the plurality of the one or more PUCCH resources for rescheduling the HARQ message 122.

In some aspects, the resource selection component 121, e.g., in conjunction with processor(s) 1312, memory 1316, and/or transceiver 1302, configured to select from the plurality of the one or more PUCCH resources for rescheduling the HARQ message 122 further comprises at least one of selecting a PUCCH resource from the plurality of the one or more PUCCH resources that has a lowest index number associated; selecting the PUCCH resource from the plurality of the one or more PUCCH resources that has a highest index number associated; or selecting the PUCCH resource from the plurality of the one or more PUCCH resources based on a function of an identification of the UE 104 or Radio Network Temporary Identifier (RNTI) of the UE 104.

In some aspects, the resource selection component 121, e.g., in conjunction with processor(s) 1312, memory 1316, and/or transceiver 1302, configured to reschedule HARQ message 122 on the first available PUCCH resource of the second slot for transmission on the PUCCH to the network entity 102 further comprises forgoing transmission of the HARQ message 122 on the first slot; and scheduling the HARQ message 122 on first available PUCCH resource of the second slot for transmission on the PUCCH to the network entity 102.

In some aspects, the resource selection component 121, e.g., in conjunction with processor(s) 1312, memory 1316, and/or transceiver 1302, configured to determine whether the first slot format 124 of the slot changes to the second slot format 125 prior to transmission of the HARQ message 122 and the CSI message 123 on the PUCCH further comprises identifying a symbol location within the first slot that is configured as an uplink symbol by the first slot format 124 for scheduled transmissions of the HARQ message 122 and the CSI message 123; and determining whether the symbol location within the first slot changes from the uplink symbol to a downlink symbol.

In some aspects, the resource selection component 121, e.g., in conjunction with processor(s) 1312, memory 1316, and/or transceiver 1302, configured to forgo transmission of the CSI message 123 based on the determination that the first slot format 124 of the first slot changes to the second slot format 125 further comprises forgoing transmission of the CSI message 123 in the symbol location within the first slot based on the determination that the symbol location within the first slot changes from the uplink symbol to the downlink symbol.

In some aspects, the resource selection component 121, e.g., in conjunction with processor(s) 1312, memory 1316, and/or transceiver 1302, configured to reschedule HARQ message 122 on the first available PUCCH resource of a second slot for transmission on the PUCCH to the network entity 102 further comprises forgoing transmission of the HARQ message 122 in the symbol location within the first slot based on the determination that the symbol location within the first slot changes from the uplink symbol to the downlink symbol; and scheduling the HARQ message 1122 on first available PUCCH resource in a subsequent symbol location within the second slot for transmission on the PUCCH to the network entity 102.

FIG. 11 illustrates a flow chart of an example of a method 1100 for wireless communication at a UE, such as the UE 104. In an example, a UE 104 can perform the functions described in method 1100 using one or more of the components described in FIGS. 1, 2, 4, and/or 13.

At block 1102, the method 1100 may schedule a HARQ message and a CSI message on a first slot for transmission on a PUCCH to a network entity based on a SPS configuration, wherein the first slot is configured in a first slot format. In an aspect, the resource selection component 121, e.g., in conjunction with processor(s) 1312, memory 1316, and/or transceiver 1302, may be configured to schedule a HARQ message 122 and a CSI message 123 on a first slot for transmission on a PUCCH to a network entity 102/180 based on a SPS configuration, wherein the first slot is configured in a first slot format 124. Thus, the UE 104, the processor(s) 1312, the resource selection component 121 or one of its subcomponents may define the means for scheduling a HARQ message and a CSI message on a first slot for transmission on a PUCCH to a network entity based on a SPS configuration, wherein the first slot is configured in a first slot format. For example, in an aspect, the UE 104 and/or the resource selection component 121 may process one or more instructions to place a HARQ message and a CSI message in a queue for transmission, and/or performs other signal processes such as described above with respect to FIG. 13.

At block 1104, the method 1100 may determine whether the first slot format of the slot changes to a second slot format prior to transmission of the HARQ message and the CSI message on the PUCCH. In an aspect, the resource selection component 121, e.g., in conjunction with processor(s) 1312, memory 1316, and/or transceiver 1302, may be configured to determine whether the first slot format 124 of the slot changes to a second slot format 125 prior to transmission of the HARQ message 122 and the CSI message 123 on the PUCCH. Thus, the UE 104, the processor(s) 1312, the resource selection component 121 or one of its subcomponents may define the means for determining whether the first slot format of the slot changes to a second slot format prior to transmission of the HARQ message and the CSI message on the PUCCH. For example, in an aspect, the UE 104 and/or the resource selection component 121 may receive one or more signals that indicate a slot format change, and/or performs other signal processes such as described above with respect to FIG. 13.

At block 1106, the method 1100 may determine availability of one or more PUCCH resources corresponding to the second slot format based on the determination that the first slot format of the slot changes to the second slot format. In an aspect, the resource selection component 121, e.g., in conjunction with processor(s) 1312, memory 1316, and/or transceiver 1302, may be configured to determine availability of one or more PUCCH resources corresponding to the second slot format 125 based on the determination that the first slot format 124 of the slot changes to the second slot format 125. Thus, the UE 104, the processor(s) 1312, the resource selection component 121 or one of its subcomponents may define the means for determining availability of one or more PUCCH resources corresponding to the second slot format based on the determination that the first slot format of the slot changes to the second slot format. For example, in an aspect, the UE 104 and/or the resource selection component 121 may receive one or more signals that indicate the amount of resources within the new slot format, and/or performs other signal processes such as described above with respect to FIG. 13.

At block 1108, the method 1100 may reschedule the HARQ message and the CSI message on a second slot for transmission on the PUCCH to the network entity based on the determination of the availability of the one or more PUCCH resources, wherein the second slot is configured in the second slot format. In an aspect, the resource selection component 121, e.g., in conjunction with processor(s) 1312, memory 1316, and/or transceiver 1302, may be configured to reschedule the HARQ message 122 and the CSI message 123 on a second slot for transmission on the PUCCH to the network entity 102/180 based on the determination of the availability of the one or more PUCCH resources, wherein the second slot is configured in the second slot format 125. Thus, the UE 104, the processor(s) 1312, the resource selection component 121 or one of its subcomponents may define the means for rescheduling the HARQ message and the CSI message on a second slot for transmission on the PUCCH to the network entity based on the determination of the availability of the one or more PUCCH resources, wherein the second slot is configured in the second slot format. For example, in an aspect, the UE 104 and/or the resource selection component 121 may process one or more instructions to place a HARQ message and CSI message in a queue for transmission, and/or performs other signal processes such as described above with respect to FIG. 13.

In some aspects, the resource selection component 121, e.g., in conjunction with processor(s) 1312, memory 1316, and/or transceiver 1302, configured to determine the availability of the one or more PUCCH resources further comprises receiving a downlink control information (DCI) from the network entity, the DCI indicating a SPS HARQ and CSI deferral field that enables rescheduling of the HARQ message and the CSI message on the second slot for transmission on the PUCCH to the network entity

In some aspects, the resource selection component 121, e.g., in conjunction with processor(s) 1312, memory 1316, and/or transceiver 1302, configured to determine the availability of the one or more PUCCH resources further comprises receiving system information broadcasted from the network entity, the system information indicating a SPS HARQ and CSI deferral field that enables rescheduling of the HARQ message and the CSI message on the second slot for transmission on the PUCCH to the network entity

In some aspects, the resource selection component 121, e.g., in conjunction with processor(s) 1312, memory 1316, and/or transceiver 1302, configured to determine the availability of the one or more PUCCH resources further comprises detecting that an amount of uplink symbols corresponding to the one or more PUCCH resources in the second slot exceeds a rescheduling threshold; and triggering a scheduling request for indicating a SPS HARQ and CSI deferral that enables rescheduling of the HARQ message and the CSI message on the second slot for transmission on the PUCCH to the network entity

In some aspects, the resource selection component 121, e.g., in conjunction with processor(s) 1312, memory 1316, and/or transceiver 1302, configured to determine the availability of the one or more PUCCH resources further comprises receiving an indication of a priority threshold for rescheduling the CSI message, the priority threshold establishing one or more types of CSI reports allowed for rescheduling; determining whether a priority level for the CSI message exceeds the priority threshold; and wherein rescheduling the HARQ message and the CSI message on the second slot for transmission on the PUCCH to the network entity further comprises rescheduling the HARQ message and the CSI message on the second slot for transmission on the PUCCH to the network entity based on the determination that the priority level for the CSI message exceeds the priority threshold

In some aspects, the one or more types of CSI reports correspond to CSI reports configured for detecting at least one of beam blocking and cell interference on one or more resources.

In some aspects, the resource selection component 121, e.g., in conjunction with processor(s) 1312, memory 1316, and/or transceiver 1302, may be configured to determine whether the second slot for transmission occurs within a maximum deferral time for transmission of rescheduled transmissions.

In some aspects, the resource selection component 121, e.g., in conjunction with processor(s) 1312, memory 1316, and/or transceiver 1302, configured to reschedule the HARQ message 122 and CSI message 123 on the second slot for transmission on the PUCCH to the network entity 102 further comprises rescheduling the HARQ message 122 and CSI message 123 on the second slot for transmission on the PUCCH to the network entity 102 based on the determination that the second slot for transmission occurs within the maximum deferral time for transmission of rescheduled transmissions.

In some aspects, the maximum deferral time for transmission of the rescheduled transmissions corresponds to a maximum number of slots after reception of a downlink message indicating expiration of a validity of the HARQ message 122 and the CSI message 123.

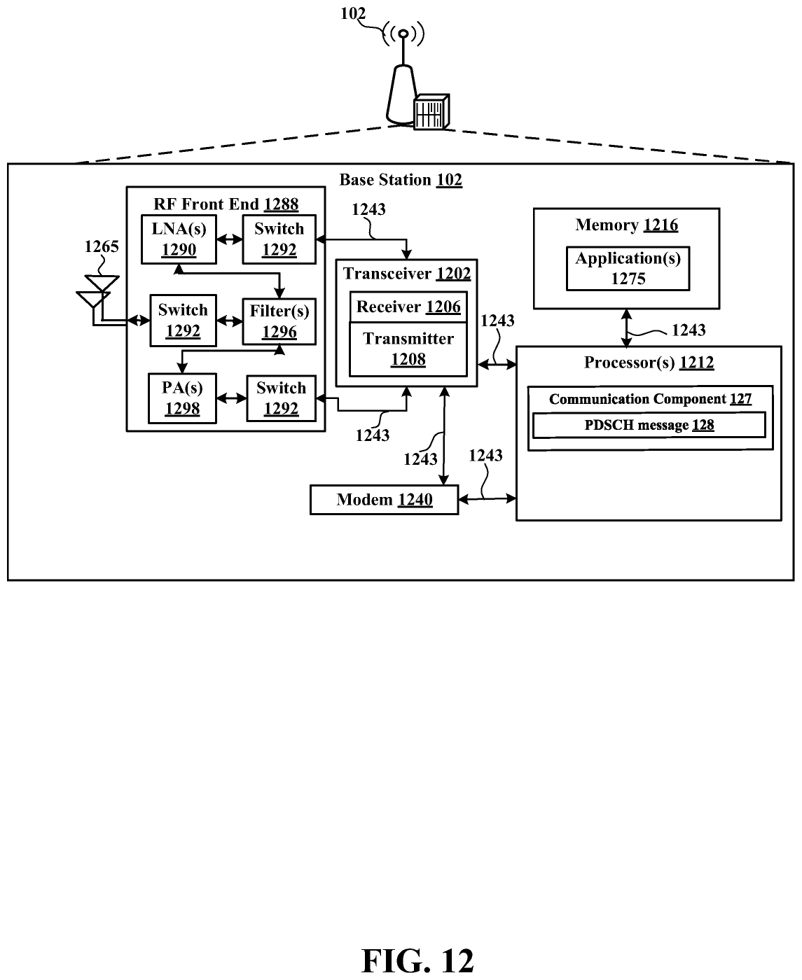

Referring to FIG. 12, one example of an implementation of a node acting as an IAB node, such as base station 102 (e.g., a base station 102 and/or gNB 180, as described above) may include a variety of components, some of which have already been described above and are described further herein, including components such as one or more processors 1212 and memory 1216 and transceiver 1202 in communication via one or more buses 1243, which may operate in conjunction with modem 1240 and/or sidelink configuration component 1242 for configuring SPS configured communications between a first UE 104 and a second UE 104′.

In an aspect, the one or more processors 1212 can include a modem 1240 and/or can be part of the modem 1240 that uses one or more modem processors. Thus, the various functions related to BS communicating component 1242 may be included in modem 1240 and/or processors 1212 and, in an aspect, can be executed by a single processor, while in other aspects, different ones of the functions may be executed by a combination of two or more different processors. For example, in an aspect, the one or more processors 1212 may include any one or any combination of a modem processor, or a baseband processor, or a digital signal processor, or a transmit processor, or a receiver processor, or a transceiver processor associated with transceiver 1202. In other aspects, some of the features of the one or more processors 1212 and/or modem 1240 associated with BS communicating component 1242 may be performed by transceiver 1202.

Also, memory 1216 may be configured to store data used herein and/or local versions of applications 1275 or BS communicating component 1242 and/or one or more of its subcomponents being executed by at least one processor 1212. Memory 1216 can include any type of computer-readable medium usable by a computer or at least one processor 1212, such as random access memory (RAM), read only memory (ROM), tapes, magnetic discs, optical discs, volatile memory, non-volatile memory, and any combination thereof. In an aspect, for example, memory 1216 may be a non-transitory computer-readable storage medium that stores one or more computer-executable codes defining BS communicating component 1242 and/or one or more of its subcomponents, and/or data associated therewith, when base station 102 is operating at least one processor 1212 to execute communication component 127 and/or one or more of its subcomponents.

Transceiver 1202 may include at least one receiver 1206 and at least one transmitter 1208. Receiver 1206 may include hardware and/or software executable by a processor for receiving data, the code comprising instructions and being stored in a memory (e.g., computer-readable medium). Receiver 1206 may be, for example, a radio frequency (RF) receiver. In an aspect, receiver 1206 may receive signals transmitted by at least one base station 102. Additionally, receiver 1206 may process such received signals, and also may obtain measurements of the signals, such as, but not limited to, Ec/Io, signal-to-noise ratio (SNR), reference signal received power (RSRP), received signal strength indicator (RSSI), etc. Transmitter 1208 may include hardware and/or software executable by a processor for transmitting data, the code comprising instructions and being stored in a memory (e.g., computer-readable medium). A suitable example of transmitter 1208 may including, but is not limited to, an RF transmitter.

Moreover, in an aspect, base station 102 may include RF front end 1288, which may operate in communication with one or more antennas 1265 and transceiver 1202 for receiving and transmitting radio transmissions, for example, wireless communications transmitted by at least one base station 102 or wireless transmissions transmitted by UE 104. RF front end 1288 may be connected to one or more antennas 1265 and can include one or more low-noise amplifiers (LNAs) 1290, one or more switches 1292, one or more power amplifiers (PAs) 1298, and one or more filters 1296 for transmitting and receiving RF signals. The antennas 1265 may include one or more antennas, antenna elements, and/or antenna arrays.

In an aspect, LNA 1290 can amplify a received signal at a desired output level. In an aspect, each LNA 1290 may have a specified minimum and maximum gain values. In an aspect, RF front end 1288 may use one or more switches 1292 to select a particular LNA 1290 and its specified gain value based on a desired gain value for a particular application.

Further, for example, one or more PA(s) 1298 may be used by RF front end 1288 to amplify a signal for an RF output at a desired output power level. In an aspect, each PA 1298 may have specified minimum and maximum gain values. In an aspect, RF front end 1288 may use one or more switches 1292 to select a particular PA 1298 and its specified gain value based on a desired gain value for a particular application.

Also, for example, one or more filters 1296 can be used by RF front end 1288 to filter a received signal to obtain an input RF signal. Similarly, in an aspect, for example, a respective filter 1296 can be used to filter an output from a respective PA 1298 to produce an output signal for transmission. In an aspect, each filter 1296 can be connected to a specific LNA 1290 and/or PA 1298. In an aspect, RF front end 1288 can use one or more switches 1292 to select a transmit or receive path using a specified filter 1296, LNA 1290, and/or PA 1298, based on a configuration as specified by transceiver 1202 and/or processor 1212.

As such, transceiver 1202 may be configured to transmit and receive wireless signals through one or more antennas 1265 via RF front end 1288. In an aspect, transceiver may be tuned to operate at specified frequencies such that UE 104 can communicate with, for example, one or more base stations 102 or one or more cells associated with one or more base stations 102. In an aspect, for example, modem 1240 can configure transceiver 1202 to operate at a specified frequency and power level based on the UE configuration of the UE 104 and the communication protocol used by modem 1240.

In an aspect, modem 1240 can be a multiband-multimode modem, which can process digital data and communicate with transceiver 1202 such that the digital data is sent and received using transceiver 1202. In an aspect, modem 1240 can be multiband and be configured to support multiple frequency bands for a specific communications protocol. In an aspect, modem 1240 can be multimode and be configured to support multiple operating networks and communications protocols. In an aspect, modem 1240 can control one or more components of UE 104 (e.g., RF front end 1288, transceiver 1202) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, the processor(s) 1212 may correspond to one or more of the processors described in connection with the UE in FIG. 4. Similarly, the memory 1216 may correspond to the memory described in connection with the UE in FIG. 4.

Referring to FIG. 13, one example of an implementation of UE 104 may include a variety of components, some of which have already been described above and are described further herein, including components such as one or more processors 1312 and memory 1316 and transceiver 1302 in communication via one or more buses 1344, which may operate in conjunction with modem 1340 and/or resource selection component 121 for configuring SPS PUCCH communications with a network entity 102.

The transceiver 1302, receiver 1306, transmitter 1308, one or more processors 1312, memory 1316, applications 1375, buses 1344, RF front end 1388, LNAs 1390, switches 1392, filters 1396, PAs 1398, and one or more antennas 1365 may be the same as or similar to the corresponding components of base station 102, as described above, but configured or otherwise programmed for base station operations as opposed to base station operations.

In an aspect, the processor(s) 1312 may correspond to one or more of the processors described in connection with the base station in FIG. 4. Similarly, the memory 1316 may correspond to the memory described in connection with the base station in FIG. 4.

The following provides an overview of examples of the present disclosure:

Example 1. A method of wireless communications at a user equipment (UE), comprising: scheduling a hybrid automatic repeat request (HARQ) message and a channel state information (CSI) message in a first slot for transmission on a physical uplink control channel (PUCCH) to a network entity based on a semi-persistent scheduling (SPS) configuration, wherein the first slot is configured in a first slot format; determining whether the first slot format of the slot changes to a second slot format prior to transmission of the HARQ message and the CSI message on the PUCCH in the first slot; forgoing transmission of the CSI message based on the determination that the first slot format of the first slot changes to the second slot format; and rescheduling the HARQ message on a second slot for transmission on the PUCCH to the network entity based on the determination that the first slot format of the slot changes to the second slot format, wherein the second slot is configured in the second slot format.

Example 2. The method of example 1, wherein the HARQ message corresponds to a SPS HARQ acknowledgement (ACK)/negative ACK (NACK) scheduled in response to an SPS physical downlink shared channel (PDSCH) message based on the SPS configuration on the PUCCH.

Example 3 The method of examples 1 and 2, wherein the HARQ message comprises a codebook of multiple bits.

Example 4. The method of examples 1-3, wherein the codebook corresponds to at least one of multiple carriers, carrier aggregation, and multiple SPS configurations.

Example 5. The method of examples 1-4, wherein the SPS configuration corresponds to a SPS PUCCH acknowledgement (ACK)/negative ACK (NACK) (AN) list that configures one or more PUCCH resources per a HARQ ACK/NACK codebook for scheduling transmission of the HARQ message.

Example 6. The method of examples 1-5, wherein the CSI message is configured for periodic transmission.

Example 7. The method of examples 1-6, further comprising determining whether the second slot for transmission occurs within a maximum deferral time for transmission of rescheduled transmissions.

Example 8. The method of examples 1-7, wherein rescheduling the HARQ message on the second slot for transmission on the PUCCH to the network entity further comprises rescheduling the HARQ message on the second slot for transmission on the PUCCH to the network entity based on the determination that the second slot for transmission occurs within the maximum deferral time for transmission of rescheduled transmissions.

Example 9. The method of examples 1-8, wherein the maximum deferral time for transmission of the rescheduled transmissions corresponds to a maximum number of slots after reception of a downlink message indicating expiration of a validity of the HARQ message and the CSI message.

Example 10. The method of examples 1-9, further comprising transmitting the HARQ message and the CSI message on the first slot on the PUCCH to the network entity based on the determination that first slot format of the slot does not change.

Example 11. The method of examples 1-10, wherein rescheduling the HARQ message on the second slot for transmission on the PUCCH to the network entity further comprises: forgoing transmission of the HARQ message on the first slot; searching for a first available PUCCH resource in the second slot; and scheduling the HARQ message on first available PUCCH resource of the second slot for transmission on the PUCCH to the network entity.

Example 12. The method of examples 1-11, wherein determining whether the first slot format of the slot changes to the second slot format prior to transmission of the HARQ message and the CSI message on the PUCCH further comprises: identifying a symbol location within the first slot that is configured as an uplink symbol by the first slot format for scheduled transmissions of the HARQ message and the CSI message; and determining whether the symbol location within the first slot changes from the uplink symbol to a downlink symbol within the second slot.

Example 13. The method of examples 1-12, wherein forgoing transmission of the CSI message based on the determination that the first slot format of the first slot changes to the second slot format further comprises forgoing transmission of the CSI message in the symbol location within the first slot based on the determination that the symbol location within the first slot changes from the uplink symbol to the downlink symbol.

Example 14. The method of examples 1-13, wherein rescheduling the HARQ message on the second slot for transmission on the PUCCH to the network entity further comprises: forgoing transmission of the HARQ message in the symbol location within the first slot based on the determination that the symbol location within the first slot changes from the uplink symbol to the downlink symbol; searching for a first available PUCCH resource at a subsequent symbol location corresponding to an uplink symbol in the second slot; and scheduling the HARQ message on first available PUCCH resource in the subsequent symbol location within the second slot for transmission on the PUCCH to the network entity.

Example 15. The method of examples 1-13, wherein searching for the first available PUCCH resource at the subsequent symbol location further comprises searching for the first available PUCCH resource based on a payload size of the HARQ message.

Example 16. The method of examples 1-15, further comprising selecting a first available PUCCH resource of one or more PUCCH resources from a SPS PUCCH acknowledgement (ACK)/negative ACK (HACK) (AN) list that configures the one or more PUCCH resources per a HARQ ACK/NACK codebook for scheduling transmission of the HARQ message.

Example 17. The method of examples 1-16, wherein rescheduling the HARQ message on the second slot for transmission on the PUCCH to the network entity further comprises rescheduling the HARQ message on the selected first available PUCCH resource of the second slot for transmission on the PUCCH to the network entity based on the determination that the first slot format of the slot changes to the second slot format.

Example 18. The method of examples 1-17, further comprising mapping the first available PUCCH resource to an uplink control information (UCI) content corresponding to one or more bits of the HARQ message.

Example 19. The method of examples 1-18, wherein rescheduling the HARQ message on the second slot for transmission on the PUCCH to the network entity further comprises multiplexing one or more bits of HARQ message with one or more bits of a new HARQ.

Example 20. The method of examples 1-19, wherein selecting the first available PUCCH resource of one or more PUCCH resources from the SPS PUCCH AN list further comprises: identifying from the one or more PUCCH resources that carriers a deferred payload of the HARQ message; determining whether a plurality of the one or more PUCCH resources are identified; and selecting from the plurality of the one or more PUCCH resources for rescheduling the HARQ message.

Example 21. The method of examples 1-20, wherein selecting from the plurality of the one or more PUCCH resources for rescheduling the HARQ message further comprises at least one of: selecting a PUCCH resource from the plurality of the one or more PUCCH resources that has a lowest index number associated; selecting the PUCCH resource from the plurality of the one or more PUCCH resources that has a highest index number associated; or selecting the PUCCH resource from the plurality of the one or more PUCCH resources based on a function of an identification of the UE or Radio Network Temporary Identifier (RNTI) of the UE.

Example 22. The method of examples 1-21, wherein rescheduling HARQ message on the first available PUCCH resource of the second slot for transmission on the PUCCH to the network entity further comprises: forgoing transmission of the HARQ message on the first slot; and scheduling the HARQ message on first available PUCCH resource of the second slot for transmission on the PUCCH to the network entity.

Example 23. The method of examples 1-22, wherein determining whether the first slot format of the slot changes to the second slot format prior to transmission of the HARQ message and the CSI message on the PUCCH further comprises: identifying a symbol location within the first slot that is configured as an uplink symbol by the first slot format for scheduled transmissions of the HARQ message and the CSI message; and determining whether the symbol location within the first slot changes from the uplink symbol to a downlink symbol.

Example 24. The method of examples 1-23, wherein forgoing transmission of the CSI message based on the determination that the first slot format of the first slot changes to the second slot format further comprises forgoing transmission of the CSI message in the symbol location within the first slot based on the determination that the symbol location within the first slot changes from the uplink symbol to the downlink symbol.

Example 25. The method of examples 1-24, wherein rescheduling HARQ message on the first available PUCCH resource of a second slot for transmission on the PUCCH to the network entity further comprises: forgoing transmission of the HARQ message in the symbol location within the first slot based on the determination that the symbol location within the first slot changes from the uplink symbol to the downlink symbol; and scheduling the HARQ message on first available PUCCH resource in a subsequent symbol location within the second slot for transmission on the PUCCH to the network entity.

Example 26. An apparatus for wireless communication, comprising: a transceiver; a memory configured to store instructions; and one or more processors communicatively coupled with the transceiver and the memory, wherein the one or more processors are configured to execute the instructions to: schedule a hybrid automatic repeat request (HARQ) message and a channel state information (CSI) message in a first slot for transmission on a physical uplink control channel (PUCCH) to a network entity based on a semi-persistent scheduling (SPS) configuration, wherein the first slot is configured in a first slot format; determine whether the first slot format of the slot changes to a second slot format prior to transmission of the HARQ message and the CSI message on the PUCCH in the first slot; forgo transmission of the CSI message based on the determination that the first slot format of the first slot changes to the second slot format; and reschedule the HARQ message on a second slot for transmission on the PUCCH to the network entity based on the determination that the first slot format of the slot changes to the second slot format, wherein the second slot is configured in the second slot format.

Example 27. The apparatus of claim 26, wherein the HARQ message corresponds to a SPS HARQ acknowledgement (ACK)/negative ACK (NACK) scheduled in response to an SPS physical downlink shared channel (PDSCH) message based on the SPS configuration on the PUCCH.

Example 28. The apparatus of claim 26, wherein the SPS configuration corresponds to a SPS PUCCH acknowledgement (ACK)/negative ACK (NACK) (AN) list that configures one or more PUCCH resources per a HARQ ACK/NACK codebook for scheduling transmission of the HARQ message.

Example 29. An apparatus for wireless communication, comprising: means for scheduling a hybrid automatic repeat request (HARQ) message and a channel state information (CSI) message in a first slot for transmission on a physical uplink control channel (PUCCH) to a network entity based on a semi-persistent scheduling (SPS) configuration, wherein the first slot is configured in a first slot format; means for determining whether the first slot format of the slot changes to a second slot format prior to transmission of the HARQ message and the CSI message on the PUCCH in the first slot; means for forgoing transmission of the CSI message based on the determination that the first slot format of the first slot changes to the second slot format; and means for rescheduling the HARQ message on a second slot for transmission on the PUCCH to the network entity based on the determination that the first slot format of the slot changes to the second slot format, wherein the second slot is configured in the second slot format.

Example 30. A non-transitory computer-readable medium, comprising code executable by one or more processors to: schedule a hybrid automatic repeat request (HARQ) message and a channel state information (CSI) message in a first slot for transmission on a physical uplink control channel (PUCCH) to a network entity based on a semi-persistent scheduling (SPS) configuration, wherein the first slot is configured in a first slot format; determine whether the first slot format of the slot changes to a second slot format prior to transmission of the HARQ message and the CSI message on the PUCCH in the first slot; forgo transmission of the CSI message based on the determination that the first slot format of the first slot changes to the second slot format; and reschedule the HARQ message on a second slot for transmission on the PUCCH to the network entity based on the determination that the first slot format of the slot changes to the second slot format, wherein the second slot is configured in the second slot format.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, hardwiring, or combinations of any of these. Features implementing functions may also be physically located at various positions, including being distributed such that portions of functions are implemented at different physical locations. Moreover, the term “or” is intended to mean an inclusive “or” rather than an exclusive “or.” That is, unless specified otherwise, or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. Also, as used herein, including in the claims, “or” as used in a list of items prefaced by “at least one of” indicates a disjunctive list such that, for example, a list of “at least one of A, B, or C” means A or B or C or AB or AC or BC or ABC (A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. A method of wireless communications at a user equipment (UE), comprising:
scheduling a hybrid automatic repeat request (HARQ) message and a channel state information (CSI) message in a first slot for transmission on a physical uplink control channel (PUCCH) to a network entity based on a semi-persistent scheduling (SPS) configuration, wherein the first slot is configured in a first slot format;
determining whether the first slot format of the slot changes to a second slot format prior to transmission of the HARQ message and the CSI message on the PUCCH in the first slot;
forgoing transmission of the CSI message based on the determination that the first slot format of the first slot changes to the second slot format; and
rescheduling the HARQ message on a second slot for transmission on the PUCCH to the network entity based on the determination that the first slot format of the slot changes to the second slot format, wherein the second slot is configured in the second slot format.

2. The method of claim 1, wherein the HARQ message corresponds to a SPS HARQ acknowledgement (ACK)/negative ACK (NACK) scheduled in response to an SPS physical downlink shared channel (PDSCH) message based on the SPS configuration on the PUCCH.

3. The method of claim 1, wherein the HARQ message comprises a codebook of multiple bits.

4. The method of claim 3, wherein the codebook corresponds to at least one of multiple carriers, carrier aggregation, and multiple SPS configurations.

5. The method of claim 1, wherein the SPS configuration corresponds to a SPS PUCCH acknowledgement (ACK)/negative ACK (NACK) (AN) list that configures one or more PUCCH resources per a HARQ ACK/NACK codebook for scheduling transmission of the HARQ message.

6. The method of claim 1, wherein the CSI message is configured for periodic transmission.

7. The method of claim 1, further comprising determining whether the second slot for transmission occurs within a maximum deferral time for transmission of rescheduled transmissions.

8. The method of claim 7, wherein rescheduling the HARQ message on the second slot for transmission on the PUCCH to the network entity further comprises rescheduling the HARQ message on the second slot for transmission on the PUCCH to the network entity based on the determination that the second slot for transmission occurs within the maximum deferral time for transmission of rescheduled transmissions.

9. The method of claim 7, wherein the maximum deferral time for transmission of the rescheduled transmissions corresponds to a maximum number of slots after reception of a downlink message indicating expiration of a validity of the HARQ message and the CSI message.

10. The method of claim 1, further comprising transmitting the HARQ message and the CSI message on the first slot on the PUCCH to the network entity based on the determination that first slot format of the slot does not change.

11. The method of claim 1, wherein rescheduling the HARQ message on the second slot for transmission on the PUCCH to the network entity further comprises:
forgoing transmission of the HARQ message on the first slot;
searching for a first available PUCCH resource in the second slot; and
scheduling the HARQ message on first available PUCCH resource of the second slot for transmission on the PUCCH to the network entity.

12. The method of claim 1, wherein determining whether the first slot format of the slot changes to the second slot format prior to transmission of the HARQ message and the CSI message on the PUCCH further comprises:
identifying a symbol location within the first slot that is configured as an uplink symbol by the first slot format for scheduled transmissions of the HARQ message and the CSI message; and
determining whether the symbol location within the first slot changes from the uplink symbol to a downlink symbol within the second slot.

13. The method of claim 12, wherein forgoing transmission of the CSI message based on the determination that the first slot format of the first slot changes to the second slot format further comprises forgoing transmission of the CSI message in the symbol location within the first slot based on the determination that the symbol location within the first slot changes from the uplink symbol to the downlink symbol.

14. The method of claim 12, wherein rescheduling the HARQ message on the second slot for transmission on the PUCCH to the network entity further comprises:
forgoing transmission of the HARQ message in the symbol location within the first slot based on the determination that the symbol location within the first slot changes from the uplink symbol to the downlink symbol;
searching for a first available PUCCH resource at a subsequent symbol location corresponding to an uplink symbol in the second slot; and
scheduling the HARQ message on first available PUCCH resource in the subsequent symbol location within the second slot for transmission on the PUCCH to the network entity.

15. The method of claim 14, wherein searching for the first available PUCCH resource at the subsequent symbol location further comprises searching for the first available PUCCH resource based on a payload size of the HARQ message.

16. The method of claim 1, further comprising selecting a first available PUCCH resource of one or more PUCCH resources from a SPS PUCCH acknowledgement (ACK)/negative ACK (HACK) (AN) list that configures the one or more PUCCH resources per a HARQ ACK/NACK codebook for scheduling transmission of the HARQ message.

17. The method of claim 16, wherein rescheduling the HARQ message on the second slot for transmission on the PUCCH to the network entity further comprises rescheduling the HARQ message on the selected first available PUCCH resource of the second slot for transmission on the PUCCH to the network entity based on the determination that the first slot format of the slot changes to the second slot format.

18. The method of claim 17, further comprising mapping the first available PUCCH resource to an uplink control information (UCI) content corresponding to one or more bits of the HARQ message.

19. The method of claim 17, wherein rescheduling the HARQ message on the second slot for transmission on the PUCCH to the network entity further comprises multiplexing one or more bits of HARQ message with one or more bits of a new HARQ.

20. The method of claim 17, wherein selecting the first available PUCCH resource of one or more PUCCH resources from the SPS PUCCH AN list further comprises:
identifying from the one or more PUCCH resources that carriers a deferred payload of the HARQ message;
determining whether a plurality of the one or more PUCCH resources are identified; and
selecting from the plurality of the one or more PUCCH resources for rescheduling the HARQ message.

21. The method of claim 20, wherein selecting from the plurality of the one or more PUCCH resources for rescheduling the HARQ message further comprises at least one of:
selecting a PUCCH resource from the plurality of the one or more PUCCH resources that has a lowest index number associated;
selecting the PUCCH resource from the plurality of the one or more PUCCH resources that has a highest index number associated; or
selecting the PUCCH resource from the plurality of the one or more PUCCH resources based on a function of an identification of the UE or Radio Network Temporary Identifier (RNTI) of the UE.

22. The method of claim 17, wherein rescheduling HARQ message on the first available PUCCH resource of the second slot for transmission on the PUCCH to the network entity further comprises:
forgoing transmission of the HARQ message on the first slot; and
scheduling the HARQ message on first available PUCCH resource of the second slot for transmission on the PUCCH to the network entity.

23. The method of claim 17, wherein determining whether the first slot format of the slot changes to the second slot format prior to transmission of the HARQ message and the CSI message on the PUCCH further comprises:
identifying a symbol location within the first slot that is configured as an uplink symbol by the first slot format for scheduled transmissions of the HARQ message and the CSI message; and
determining whether the symbol location within the first slot changes from the uplink symbol to a downlink symbol.

24. The method of claim 23, wherein forgoing transmission of the CSI message based on the determination that the first slot format of the first slot changes to the second slot format further comprises forgoing transmission of the CSI message in the symbol location within the first slot based on the determination that the symbol location within the first slot changes from the uplink symbol to the downlink symbol.

25. The method of claim 17, wherein rescheduling HARQ message on the first available PUCCH resource of a second slot for transmission on the PUCCH to the network entity further comprises:
forgoing transmission of the HARQ message in the symbol location within the first slot based on the determination that the symbol location within the first slot changes from the uplink symbol to the downlink symbol; and
scheduling the HARQ message on first available PUCCH resource in a subsequent symbol location within the second slot for transmission on the PUCCH to the network entity.

26. An apparatus for wireless communication, comprising:
a transceiver;
a memory configured to store instructions; and
one or more processors communicatively coupled with the transceiver and the memory, wherein the one or more processors are configured to execute the instructions to:
schedule a hybrid automatic repeat request (HARQ) message and a channel state information (CSI) message in a first slot for transmission on a physical uplink control channel (PUCCH) to a network entity based on a semi-persistent scheduling (SPS) configuration, wherein the first slot is configured in a first slot format;
determine whether the first slot format of the slot changes to a second slot format prior to transmission of the HARQ message and the CSI message on the PUCCH in the first slot;
forgo transmission of the CSI message based on the determination that the first slot format of the first slot changes to the second slot format; and
reschedule the HARQ message on a second slot for transmission on the PUCCH to the network entity based on the determination that the first slot format of the slot changes to the second slot format, wherein the second slot is configured in the second slot format.

27. The apparatus of claim 26, wherein the HARQ message corresponds to a SPS HARQ acknowledgement (ACK)/negative ACK (NACK) scheduled in response to an SPS physical downlink shared channel (PDSCH) message based on the SPS configuration on the PUCCH.

28. The apparatus of claim 26, wherein the SPS configuration corresponds to a SPS PUCCH acknowledgement (ACK)/negative ACK (HACK) (AN) list that configures one or more PUCCH resources per a HARQ ACK/NACK codebook for scheduling transmission of the HARQ message.

29. An apparatus for wireless communication, comprising:
means for scheduling a hybrid automatic repeat request (HARQ) message and a channel state information (CSI) message in a first slot for transmission on a physical uplink control channel (PUCCH) to a network entity based on a semi-persistent scheduling (SPS) configuration, wherein the first slot is configured in a first slot format;
means for determining whether the first slot format of the slot changes to a second slot format prior to transmission of the HARQ message and the CSI message on the PUCCH in the first slot;
means for forgoing transmission of the CSI message based on the determination that the first slot format of the first slot changes to the second slot format; and
means for rescheduling the HARQ message on a second slot for transmission on the PUCCH to the network entity based on the determination that the first slot format of the slot changes to the second slot format, wherein the second slot is configured in the second slot format.

30. A non-transitory computer-readable medium, comprising code executable by one or more processors to:
schedule a hybrid automatic repeat request (HARQ) message and a channel state information (CSI) message in a first slot for transmission on a physical uplink control channel (PUCCH) to a network entity based on a semi-persistent scheduling (SPS) configuration, wherein the first slot is configured in a first slot format;
determine whether the first slot format of the slot changes to a second slot format prior to transmission of the HARQ message and the CSI message on the PUCCH in the first slot;
forgo transmission of the CSI message based on the determination that the first slot format of the first slot changes to the second slot format; and
reschedule the HARQ message on a second slot for transmission on the PUCCH to the network entity based on the determination that the first slot format of the slot changes to the second slot format, wherein the second slot is configured in the second slot format.
